(19) United States
(12) Patent Application Publication
(10) Pub. No.: US 2026/0099129 A1
(43) Pub. Date: Apr. 9, 2026

(54) CONNECTED HOME ANALYTICS SYSTEM

(71) Applicant: State Farm Mutual Automobile Insurance Company, Bloomington, IL (US)

(72) Inventor: Ryan Michael Gross, Normal, IL (US)

(73) Assignee: State Farm Mutual Automobile Insurance Company, Bloomington, IL (US)

(21) Appl. No.: 18/962,903

(22) Filed: Nov. 27, 2024

Related U.S. Application Data
(60) Provisional application No. 63/703,715, filed on Oct. 4, 2024.
(60) Provisional application No. 63/718,039, filed on Nov. 8, 2024.

(51) Int. Cl. G05B 19/042

(52) U.S. Cl. CPC G05B 19/042; G05B 2219/2642

(57) ABSTRACT

A connected home analytics system may (1) ingest first operational information from a first connected device of a domicile and second operational information from a second connected device of the domicile; (2) identify, using at least one machine learning model, one or more conditions of the domicile based upon a combination of the first operational information and the second operational information; and (3) initiate one or more actions responsive to identifying the one or more conditions of the domicile.

### CROSS-REFERENCE TO RELATED APPLICATIONS

This application claims priority to and the benefit of U.S. Provisional Patent Application No. 63/718,039, filed Nov. 8, 2024, and to U.S. Provisional Patent Application No. 63/703,715, filed Oct. 4, 2024, each of which is incorporated herein by reference in its entirety.

### FIELD OF THE INVENTION

The present disclosure generally relates to managing a connected home or property. More particularly, the present disclosure relates to ingesting information from multiple connected devices of a connected home or property, and detecting, inferring and responding to various conditions within the connected home or property.

### BACKGROUND

With the proliferation of the “internet of things,” more household devices and items are gaining communication and network connectivity capabilities. The new capabilities may enable easier data detection and more accurate information and metrics. However, coordination between disparate connected devices traditionally may have been lacking. Additionally, responding to conditions associated with connected devices within the home generally may be limited to responding to specific rule-based responses with the context of pre-defined detectable scenarios within the home.

Accordingly, conventional connected analytics systems may be limited in their ability to detect, identify, and/or respond to conditions or other issues within or associated with homes, domiciles, and/or other properties. Conventional techniques may also have certain other ineffectiveness, inefficiencies, encumbrances, and/or other drawbacks as well.

### BRIEF SUMMARY

A connected home analytics system may be provided that, inter alia, (i) identifies conditions of a domicile based upon operational information from various connected devices, and (ii) initiates various actions in response to the identified conditions of the domicile, or other building. For instance, the actions may include providing notifications and/or recommendations to a user via a user interface that may be presented to the user, such as on a mobile device or other computing device. Additionally or alternatively, some actions may be automatically initiated by the connected home analytics system, such as activating and/or actuating various connected devices and/or other systems within the domicile.

In one aspect, a connected home analytics system that initiates actions in response to identifying various conditions may be provided. The connected home analytics system may include one or more local or remote processors, servers, sensors, memory units, transceivers, mobile devices, wearables, smart watches, smart glasses or contacts, Augmented Reality (AR) glasses, Virtual Reality (VR) headsets, mixed or extended reality headsets, voice bots, chat bots, ChatGPT bots, generative AI bots, and/or other electronic or electrical components, which may be in wired or wireless communication with one another and/or operate as input and/or output devices. For instance, the connected home analytics system may include one or more memory devices having instructions stored thereon that, when executed by one or more processors, cause the one or more processors to perform several operations, including (1) ingesting first operational information from a first connected device of a domicile and second operational information from a second connected device of the domicile; (2) identifying, using at least one machine learning model, one or more conditions of the domicile based upon a combination of the first operational information and the second operational information; and/or (3) initiating one or more actions responsive to identifying the one or more conditions of the domicile. The computer system may include additional, less, or alternate functionality, including that discussed elsewhere herein.

In another aspect, a computer-implemented method for performing connected home analytics and/or initiating actions in response to identifying various conditions may be provided. The computer-implemented method may be implemented via one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, generative AI bots, and/or other electronic or electrical components, which may be in wired or wireless communication with one another and/or operate as input and/or output devices. For instance, the computer-implemented method may include (1) ingesting operational information from a first connected device of a domicile; (2) identifying, using at least one machine learning model, one or more conditions of the domicile based upon the first operational information; (3) identifying, using the at least one machine learning model, a second connected device of the domicile based upon the one or more conditions of the domicile and a functionality of the second connected device; and/or (4) initiating one or more actions for responding to the one or more conditions of the domicile using the second connected device responsive to identifying the one or more conditions of the domicile and to identifying the second connected device. The method may include additional, less, or alternate functionality, including that discussed elsewhere.

In another aspect, a non-transitory computer-readable medium comprising instructions stored thereon that, when executed by one or more processors, cause the one or more processors to perform various functionality and operations. For instance, the functionality and operations may include (1) ingesting first operational information from a first connected device of a domicile and second operational information from a second connected device of the domicile; (2) determining, using at least one machine learning model, a first characteristic of the domicile based upon the first operational information and a second characteristic of the domicile based upon the second operational information; (3) identifying, using the at least one machine learning model, one or more conditions of the domicile based upon a correlation between the first characteristic and the second characteristic; and/or (4) initiating one or more actions responsive to identifying the one or more conditions of the domicile. The instructions may direct additional, less, or alternate functionality, including that discussed elsewhere herein.

In another aspect, a computer-implemented method for utilizing a trained generative artificial intelligence model to identify an issue within a property may be provided. The computer-implemented method may be implemented via one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, generative AI bots, and/or other electronic or electrical components, which may be in wired or wireless communication with one another and/or operate as input and/or output devices. For instance, the computer-implemented method may include (1) receiving (or retrieving from a local or remote memory), via one or more local or remote processors (and/or associated transceivers) historical sensor data from one or more smart devices located within the property; (2) inputting, via the one or more processors, the historical sensor data into a generative artificial intelligence model to train the generative artificial intelligence model using the historical sensor data, the generative artificial intelligence model being configured to identify one or more current or future issues within the property; (3) generating, via one or more devices, processors, or sensors mounted on or withing the property, new sensor data in real time or near real time; (4) retrieving from a memory or receiving, via the one or more processors and/or associated transceivers, the new sensor data; (5) inputting, via the one or more processors, the new sensor data into the trained generative artificial intelligence model to identify at least one current or future issue within the property and location thereof, the at least current or future issue causing or being likely to cause damage to the property; (6) based upon the at least one current or future issue within the property, generating, via the one or more processors, one or more corrective actions intending to (i) mitigate damage caused by the at least one current or future issue, and/or (ii) prevent damage caused by the at least one current or future issue (the one or more corrective actions being implemented, at least in part, by one or more local or remote processors); (7) generating, via the one or more processors, a generative AI tailored message or electronic notification to be presented or displayed via a user device (such as displayed on a display screen and/or audibly presented via a voice bot), the message containing the at least one current or future issue, a location thereof, and/or the one or more corrective actions; and/or (8) transmitting, via the one or more processors and/or associated transceivers, the message to the user device for audible and/or visual presenting to a user to facilitate mitigating or preventing property damage and/or implementing corrective actions. The method may include additional, less, or alternate functionality, including that discussed elsewhere.

In some aspects, the computer-implemented method may further include the trained artificial intelligence model performing a diagnostic analysis of the one or more devices within the property. The diagnostic analysis may include (1) detecting an origination location within the property for the one or more current or future issues within the property; (2) determining one or more devices as a source of the one or more current or future issues; (3) generating an elongated (or generative AI tailored) message, the elongated message describing the origination location within the property and the source of the one or more current or future issues; and/or (4) transmitting the elongated message to the user via the user device. The origination location may be at least one of the following: an outlet, a junction box, or a breaker panel. Upon determining the source of the one or more current or future issues to be one or more devices located within the property, the trained artificial intelligence model may (1) retrieve firmware and software data from the one or more devices; (2) analyze the firmware and software data; (3) generate a notification containing a recommendation for one or more new devices, the one or more new devices having an updated firmware and software; and/or (4) transmit the notification for presentation to the user via the user device. The computer-implemented method may further include (1) the trained artificial intelligence model estimating a potential loss amount for each of the one or more corrective actions via one or more processors; (2) generating a level of severity for each of the one more corrective actions based in part upon the potential loss amount; (3) generating a prioritized list of the one or more corrective actions; and/or (4) transmitting the prioritized list to the user via the user device, wherein the prioritized list displays (or otherwise presents, such as audibly) the level of severity or the potential loss amount for the one or more corrective actions. The one or more corrective actions may include at least one of: a preferred contractor contact number, a list of local contractors, or a recommendation for one or more new devices. Upon providing the preferred contractor contact number the trained generative artificial intelligence model may present a call option to the user via the user device.

In another aspect, a diagnostic analysis device may be provided. The diagnostic analysis device may include one or more local or remote processors, servers, sensors, memory units, transceivers, mobile devices, wearables, smart watches, smart glasses or contacts, Augmented Reality (AR) glasses, Virtual Reality (VR) headsets, mixed or extended reality headsets, voice bots, chat bots, ChatGPT bots, generative AI bots, and/or other electronic or electrical components, which may be in wired or wireless communication with one another and/or operate as input and/or output devices. For instance, the diagnostic analysis device may include at least one processor in communication with at least one memory device, the diagnostic analysis device utilizing a trained generative artificial intelligence model to identify an issue within a property, the at least one processor of the diagnostic analysis device programmed to (1) receive via one or more transceivers historical sensor data from one or more smart devices located within the property; (2) input the historical sensor data into a generative artificial intelligence model; (3) train the generative artificial intelligence model using the historical sensor data, the generative artificial intelligence model is configured to identify one or more current or future issues within the property; (4) retrieve from a memory via one or more devices within the property using one or more processors new sensor data in real time; (5) input the new sensor data into the trained generative artificial intelligence model; (6) identify one or more current or future issues within the property; (7) generate one or more corrective actions intending to mitigate damage caused by the one or more current issues or prevent damage caused by the one or more future issues; (8) generate a (generative AI tailored) message to be presented to a user, the message containing at least the one or more corrective actions; and/or (9) transmit, via one or more transceivers, the message for presentation to the user via a user device (such as visually and/or audibly). The device may include additional, less, or alternate functionality, including that discussed elsewhere herein.

In some aspects, the trained artificial intelligence model may perform a diagnostic analysis of the one or more devices within the property. The diagnostic analysis may include (1) detecting an origination location within the property for the one or more current or future issues within the property; (2) determining one or more devices as a source of the one or more current or future issues; (3) generating an elongated (or generative AI tailored) message, the elongated message describing the origination location within the property and the source of the one or more current or future issues; and/or (4) transmitting the elongated message to the user via the user device. The origination location may be at least one of the following: an outlet, a junction box, or a breaker panel. Upon determining the source of the one or more current or future issues to be one or more devices located within the property, the trained artificial intelligence model may (i) retrieve firmware and software data from the one or more devices; (ii) analyze the firmware and software data; (iii) generate a notification containing a recommendation for one or more new devices, the one or more new devices having an updated firmware and software; and/or (iv) transmit the notification for presentation to the user via the user device. The trained artificial intelligence model may (1) estimate a potential loss amount for each of the one or more corrective actions via one or more processors; (2) generate a level of severity for each of the one more corrective actions based in part upon the potential loss amount; (3) generate a prioritized list of the one or more corrective actions; and/or (4) transmit the prioritized list to the user via the user device, wherein the prioritized list displays (and/or audibly presents) the level of severity or the potential loss amount for the one or more corrective actions. The one or more corrective actions may include at least one of identifying: a preferred contractor contact number, a list of local contractors, or a recommendation for one or more new devices. Upon providing the preferred contractor contact number the trained generative artificial intelligence model may present a call option to the user via the user device.

In another aspect, a non-transitory computer-readable medium comprising instructions stored thereon that, when executed by one or more processors, cause the one or more processors to perform various functionality and operations. For instance, the functionality and operations may include (1) receiving via one or more transceivers historical sensor data from one or more smart devices located within a property; (2) inputting the historical sensor data into a generative artificial intelligence model; (3) training the generative artificial intelligence model using the historical sensor data, the generative artificial intelligence model is configured to identify one or more current or future issues within the property; (4) retrieving from a memory via one or more devices within the property using one or more processors new sensor data in real time; (5) inputting the new sensor data into the trained generative artificial intelligence model; (6) identifying one or more current or future issues within the property; (7) generating one or more corrective actions intending to mitigate damage caused by the one or more current issues or prevent damage caused by the one or more future issues; (8) generating a (generative AI tailored) message to be presented to a user (such as visually and/or audibly), the message containing at least the one or more corrective actions; and/or (9) transmitting, via one or more transceivers, the message for visual and/or verbal presentation to the user via a user device. The instructions may direct additional, less, or alternate functionality, including that discussed elsewhere herein.

In some aspects, wherein the trained artificial intelligence model performs a diagnostic analysis of the one or more devices within the property. The diagnostic analysis may include (1) detecting an origination location within the property for the one or more current or future issues within the property; (2) determining one or more devices as a source of the one or more current or future issues; (3) generating an elongated (or generative AI tailored) message, the elongated message describing the origination location within the property and the source of the one or more current or future issues; and/or (4) transmitting the elongated message to the user via the user device. The origination location may be at least one of the following: an outlet, a junction box, or a breaker panel. Upon determining the source of the one or more current or future issues to be one or more devices located within the property, the trained artificial intelligence model may (i) retrieve firmware and software data from the one or more devices; (ii) analyze the firmware and software data; (iii) generate a notification containing a recommendation for one or more new devices, the one or more new devices having an updated firmware and software; and/or (iv) transmit the notification for presentation to the user via the user device. The trained artificial intelligence model may further performs operations including (1) estimating a potential loss amount for each of the one or more corrective actions via one or more processors; (2) generating a level of severity for each of the one more corrective actions based in part upon the potential loss amount; (3) generating a prioritized list of the one or more corrective actions; and/or (4) transmitting the prioritized list to the user via the user device for visual and/or verbal presentation, wherein the prioritized list displays and/or audibly presents the level of severity or the potential loss amount for the one or more corrective actions. The one or more corrective actions may include at least one of identifying: a preferred contractor contact number, a list of local contractors, or a recommendation for one or more new devices.

In another aspect, a computer-implemented method for utilizing a trained generative artificial intelligence model to identify an issue within a property may be provided. The computer-implemented method may be implemented via one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, generative AI bots, and/or other electronic or electrical components, which may be in wired or wireless communication with one another and/or operate as input and/or output devices. For instance, the computer-implemented method may include (1) receiving, via one or more processors, sensor data from one or more smart devices; (2) processing, via the one or more processors, the sensor data using a generative artificial intelligence (GAI) model trained to identify one or more current or future issues within the property, at least one of a location or a source of the one or more current or future issues, and one or more proposed solutions for addressing the one or more current or future issues using the sensor data; (3) generating, using the GAI model, a description describing the one or more current or future issues, the at least one of the location or the source, and the one or more proposed solutions; (4) generating, via the one or more processors, a user interface including the description and one or more selectable options, each selectable option configured to allow a user to initiate a corresponding proposed solution of the one or more proposed solutions; (5) receiving, via the user interface, a selection from the user of a first selectable option from among the one or more selectable options; and/or (6) initiating, via the one or more processors, an action to implement a first proposed solution of the one or more proposed solutions corresponding to the first selectable option. The method may include additional, less, or alternate functionality, including that discussed elsewhere.

In another aspect, a connected home analytics system may be provided. The connected home analytics system may include one or more local or remote processors, servers, sensors, memory units, transceivers, mobile devices, wearables, smart watches, smart glasses or contacts, Augmented Reality (AR) glasses, Virtual Reality (VR) headsets, mixed or extended reality headsets, voice bots, chat bots, ChatGPT bots, generative AI bots, and/or other electronic or electrical components, which may be in wired or wireless communication with one another and/or operate as input and/or output devices. For instance, the connected home analytics system may include one or more memory devices having instructions stored thereon that, when executed by one or more processors, cause the one or more processors to perform several operations, including (1) receiving, via the one or more processors, sensor data from one or more smart devices of a property; (2) processing, via the one or more processors, the sensor data using a generative artificial intelligence (GAI) model trained to identify one or more current or future issues within the property, at least one of a location or a source of the one or more current or future issues, and one or more proposed solutions for addressing the one or more current or future issues using the sensor data; (3) generating, using the GAI model, a description describing the one or more current or future issues, the at least one of the location or the source, and the one or more proposed solutions; (4) generating, via the one or more processors, a user interface including the description and one or more selectable options, each selectable option configured to allow a user to initiate a corresponding proposed solution of the one or more proposed solutions; (5) receiving, via the user interface, a selection from the user of a first selectable option from among the one or more selectable options; and/or (6) initiating, via the one or more processors, an action to implement a first proposed solution of the one or more proposed solutions corresponding to the first selectable option. The computer system may include additional, less, or alternate functionality, including that discussed elsewhere herein.

In another aspect, a non-transitory computer-readable medium comprising instructions stored thereon that, when executed by one or more processors, cause the one or more processors to perform various functionality and operations. For instance, the functionality and operations may include (1) receiving, via the one or more processors, sensor data from one or more smart devices of a property; (2) processing, via the one or more processors, the sensor data using a generative artificial intelligence (GAI) model trained to identify one or more current or future issues within the property, at least one of a location or a source of the one or more current or future issues, and one or more proposed solutions for addressing the one or more current or future issues using the sensor data; (3) generating, using the GAI model, a description describing the one or more current or future issues, the at least one of the location or the source, and the one or more proposed solutions; (4) generating, via the one or more processors, a user interface including the description and one or more selectable options, each selectable option configured to allow a user to initiate a corresponding proposed solution of the one or more proposed solutions; (5) receiving, via the user interface, a selection from the user of a first selectable option from among the one or more selectable options; and/or (6) initiating, via the one or more processors, an action to implement a first proposed solution of the one or more proposed solutions corresponding to the first selectable option. The instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

There are shown in the drawings arrangements which are presently discussed, it being understood, however, that the present embodiments are not limited to the precise arrangements and are instrumentalities shown, wherein:

FIG. 1 is a block diagram of an exemplary connected home analytics computer system, according to some embodiments.

FIG. 2 is a block diagram of an exemplary connected home analytics system, according to some embodiments.

FIG. 3 is a flow diagram of an exemplary computer-implemented or computer-based process of performing connected home analytics, according to some embodiments.

FIG. 4 is an exemplary connected home notification page provided to a user via the connected home analytics system of FIG. 1, according to some embodiments.

FIG. 5 is a flow diagram of an example computer-implemented or computer-based method of utilizing a trained artificial intelligence model to identify issues within a property.

FIG. 6 is a flow diagram of an example computer-implemented or computer-based method of utilizing a trained artificial intelligence model to identify issues within a property.

The Figures depict preferred embodiments for purposes of illustration only. One skilled in the art will readily recognize from the following discussion that alternative embodiments of the systems and methods illustrated herein may be employed without departing from the principles of the present embodiments described herein.

### DETAILED DESCRIPTION

The present embodiments relate to, inter alia, a connected home analytics computer system that performs connected home analytics using, in part, operational information from multiple connected devices within a smart home or other connected property (e.g., a retail space, a restaurant) to identify and respond to various conditions within the smart home or other connected property. For instance, the connected home analytics computer system may generate various alerts and/or notifications regarding the identified conditions to a user via a user device. In some instances, the connected home analytics computer system may additionally or alternative automatically initiate or allow the user to initiate various responsive actions using relevant connected devices within the smart home or other connected property.

The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, generative AI bots, InstructGPT bots, Codex bots, Google Bard bots, and/or other electronic or electrical components, which may be in wired or wireless communication with one another. The computer system may include additional, less, or alternate functionality and/or operations, including that discussed elsewhere herein.

### Overview

Referring to the Figures, computer systems and computer-implemented methods for performing connected home analytics may be provided. For example, the computer system may be configured to ingest operational information from connected devices within a domicile (e.g., a smart home or other connected property). The computer system may then identify one or more conditions within the domicile based upon various characteristics and/or correlations identified or inferred from the ingested operational information and, in some instances, other information obtained by the computer system regarding the user's domicile and/or the connected devices. The computer system may then initiate various responsive actions to the identified conditions within the domicile. In some instances, the computer system may generate and provide the user with various alerts, notifications, and/or recommendations regarding the identified conditions. In certain embodiments, the computer system may additionally or alternatively automatically initiate and/or provide the user with selectable options (e.g., via a user interface provided on a user device of the user) to initiate various response actions using connected devices within or associated with the user's domicile.

In some embodiments, the alerts, notifications, recommendations, and/or selectable options may be provided, presented, or otherwise outputted to the user in various other manners, such as audibly via a voice bot or chatbot, or visually or graphically via a computing device display, such as a mobile device, VR headset, AR glasses, a smart vehicle control console or display, or other computing devices, including those mentioned elsewhere herein.

The computer systems and computer-implemented methods described herein may utilize trained machine learning models, such as large language models (LLMs), to ingest data from disparate connected home devices and to identify and/or infer various conditions (e.g., potential future issues, currently occurring issues) associated with the user's home and/or the connected home devices to generate and provide users with specific, personalized notifications and/or recommendations (e.g., step-by-step directions) to prevent and/or mitigate the identified conditions.

Traditional smart devices and applications have provided isolated, device-specific alerts (e.g., an electrical monitoring device may tell a user that it has detected an electrical issue). However, traditional smart devices and applications have not allowed for cross-correlation of operational information from multiple disparate devices to be used to infer a variety of potentially interrelated issues within the user's home and/or to provide additional context and specificity regarding detected issues within the user's home.

Beneficially, the computer systems and computer-implemented methods described herein may provide technical solutions to technical problems by allowing for the effective cross-correlation of operational information from a variety of disparate connected home devices by using the ability of LLMs to draw inferences between data sets of the disparate connected devices. By effectively cross correlating the operational information of the disparate connected devices, the computer systems described herein are able to identify interrelated issues and/or more specific conditions within the user's house than possible with traditional connected devices on their own. That is, by taking information derived from multiple devices within a connected home, the computer systems described herein may assess the operational information from all of the connected devices and effectively generate an analysis of an actual problem occurring in the user's house rather than just delivering multiple isolated messages to the homeowner based upon various singular fault or error codes generated by single devices in isolation. Furthermore, the computer systems and computer-implemented methods described herein allow for homeowners, who may be uneducated or inexperienced with assessing and/or responding to various issues or conditions within their homes, to be provided with clear and concise explanations of identified issues or conditions and actionable insights the homeowners may take to prevent potential damage within their home and/or mitigate damage caused by an ongoing issue.

### Exemplary Connected Home Analytics Computer System

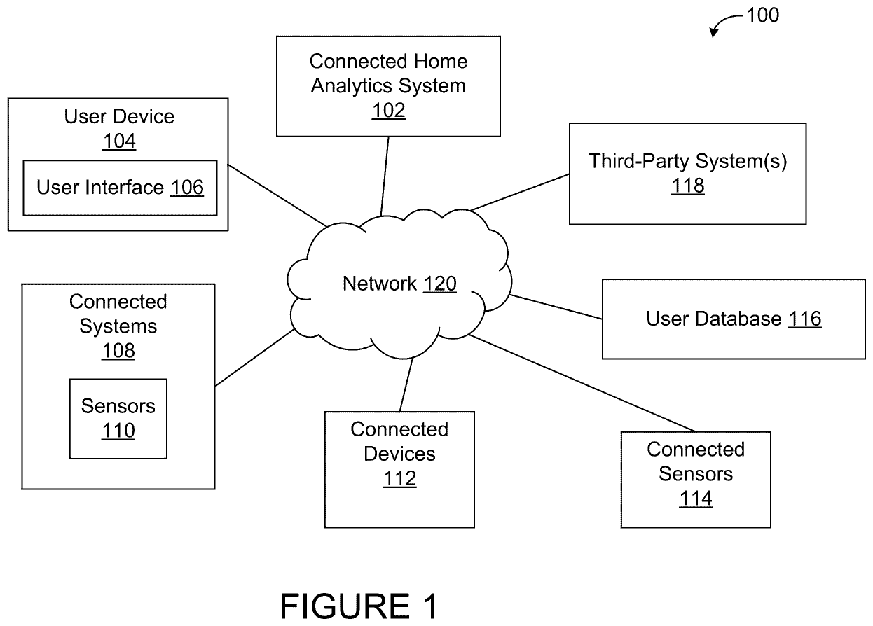

Referring to FIG. 1, a block diagram of an exemplary connected home analytics computer system, shown as connected home analytics computer system 100, is shown, according to some embodiments. The connected home analytics computer system 100 may include a connected home analytics system 102, a user device 104 having a user interface 106, various smart systems and devices, shown as connected systems 108 having various sensors 110, connected devices 112, and/or connected sensors 114. As used herein, the terms “smart home,” “smart system,” “smart device,” “smart property,” “connected home,” “connected system,” “connected device,” “connected property,” etc., may be used to signify that a system, device, home, property, or other asset includes various hardware and software components configured to enable communication between the system, device, home, property, or other asset and various other systems and devices (e.g., via a short- or long-range communication network protocol) to allow for the transfer of information and/or operation commands.

The connected home analytics computer system 100 may further include a user database 116. The connected home analytics computer system 100 may also include one or more third-party systems 118 associated with various third-party entities. The components of the connected home analytics computer system 100 may be connected, in wired or wireless communication, via a network 120. It should be noted that the number and type of components shown is merely illustrative and, in some embodiments, implementations of the connected home analytics computer system 100 may have additional, fewer, and/or different components than those illustrated in FIG. 1, including those mentioned elsewhere herein.

In some embodiments, the connected home analytics system 102 may be associated with a provider (e.g., a company or an entity) that provides protective services (e.g., insurance) and/or various other services to a user or owner of a property (e.g., a user or owner associated with the user device 104), a company or service provider (e.g., an entity associated with the third-party system 118), and/or over one or more assets, such as the connected systems 108, the connected devices 112, the connected sensors 114, a vehicle (e.g., a car, a truck, a recreational vehicle (RV), an all-terrain vehicle (ATV), personal belongings, personal articles, etc.), real property (e.g., a house, a condominium, etc.), a business, etc.

As will be described herein, the connected home analytics system 102 may be configured to utilize various machine learning models (e.g., large language models) to identify potential conditions and/or issues within a smart home or other connected property (e.g., a retail space, a restaurant) based upon information ingested from a combination of multiple connected devices (e.g., the connected systems 108, the connected devices 112, the connected sensors 114, etc.). The connected home analytics system 102 may additionally be configured to initiate various actions responsive to identified conditions and/or issues within the smart home or other connected property.

In some embodiments, the connected home analytics system 102 may be implemented using cloud computing services. In certain embodiments, the connected home analytics system 102 may be implemented using one or more computing devices, for example, operating alone and/or in combination. In various embodiments, the connected home analytics system 102 may be implemented using computing architectures like multiple distributed servers, and/or similar computing devices and/or systems. In some embodiments, the connected home analytics system 102 may be another suitable computing system, for example, distributed across multiple systems or devices (e.g., which may be located within a single building or facility, or distributed across multiple different buildings or facilities), or within a single computer (e.g., one server, housing, etc.). All such implementations are contemplated herein.

As shown, the connected home analytics system 102 may be configured to communicate with the user device 104. The user device 104 may include one or more human-machine interfaces or client interfaces, shown as user interface 106 (e.g., a graphical user interface, a text-based computer interface, a client-facing web service, a web service that provides pages to a web client, etc.), for example for controlling, viewing, and/or otherwise interfacing with the connected home analytics system 102. The user device 104 may include a personal mobile computing device (e.g., a smart phone, a tablet, a mobile device, a wearable, smart glasses, a smart watch, etc.). The user device 104 may include a computer workstation, a client terminal, a remote or local interface, and/or any other user interface device. The user device 104 may be a stationary terminal (e.g., a desktop computer, a laptop computer, a tablet, or another suitable non-mobile device).

In some embodiments, information/data associated with the user device 104 may be communicated to the connected home analytics system 102. In certain embodiments, the user device 104 itself may be configured to communicate information/data to the connected home analytics system 102. In various embodiments, a device coupled to the user device 104, a component implemented with the user device 104, an application or program housed and/or executed on the user device 104, and/or another suitable component associated with the user device 104 may be configured to communicate information/data to the connected home analytics system 102.

The connected home analytics system 102 may also be configured to receive information/data associated with the user device 104. For example, the user device 104 may (e.g., automatically, or in response to an input from a user or operator, etc.) communicate geolocation data (e.g., GPS data) associated with the user device 104 and, in some instances, telematics data (e.g., vehicle telematics data such as acceleration, braking, cornering, location, heading, speed, GPS, lane information, route, direction, driver, passenger, and/or other driving data associated with a vehicle) associate with a vehicle of the user to the connected home analytics system 102. The user device 104 may communicate real-time and/or historic geolocation and/or telematics data associated with the user device 104 and/or the vehicle of the user to the connected home analytics system 102.

In some embodiments, a user or operator may opt-in to sharing geolocation and/or telematics data with the connected home analytics system 102, such that the user device 104 communicates geolocation and/or telematics data to the connected home analytics system 102 at predetermined times (e.g., hourly, daily, weekly, etc.), in predetermined locations (e.g., in an identified geofenced location, for example when “at home” or “at work,” etc.), during use of predetermined applications, services, and/or interfaces associated with the user device 104 (e.g., a navigation/map application, a transportation or rental application, etc.), and/or other similar scenarios.

In some embodiments, the connected home analytics system 102 may be configured to receive information/data associated with various connected devices (e.g., “smart” devices, Internet-of-Things (IoT) devices), such as the connected systems 108, the connected devices 112, and/or the connected sensors 114. The connected systems 108 may include a variety of network-connected systems within a connected home or property and configured to communicate information over a network (e.g., the network 120). For example, the connected systems 108 may include a home temperature control system, a home security system, a home internet network system, etc. In some instances, the connected systems 108 may include various sensors 110 (e.g., cameras, temperature sensors, moisture detection sensors, electrical monitoring sensors, leak detection sensors, pressures sensors, etc.) configured to detect or otherwise monitor various conditions within or otherwise associated with the connected systems 108.

The connected devices 112 may include various additional network-connected devices within a connected home or property and configured to communicate information to the connected home analytics system 102 over a network (e.g., the network 120). For example, the smart home devices may include various network-connected lights, window blinds or shutters, water heaters, driers, furnaces, refrigerators, automatic shutoff devices (e.g., smart valves for gas lines and/or plumbing lines), garage door openers, fans, gaming systems or devices, speakers, etc.

The connected sensors 114 may include various additional network-connected sensors configured to detect or otherwise monitor various conditions within a connected home or property and configured to communicate information to the connected home analytics system 102 over a network (e.g., the network 120). For example, the connected sensors 114 may include various cameras (e.g., security cameras, smart doorbell cameras), temperature sensors, moisture detection sensors, water sensors, electrical sensors (e.g., sensors configured to detect electrical issues within a connected home or property), leak detection sensors, pressures sensors, flowrate sensors, door sensors, motion/occupancy sensors, light sensors, accelerometers, gas detection sensors, air quality sensors, mold or mildew sensors, odor sensors, etc., installed within the connected home or property, or embedded within the connected home materials, such as within siding, roofing materials, windows, etc.

In some instances, the connected systems 108, the connected devices 112, and the connected sensors 114 may be configured to transmit a variety of operational information (e.g., fault codes, operation statuses, sensor readings, etc.) to the connected home analytics system 102 to be utilized to identify and respond to various conditions or potentially issues within a connected home or property, as will be described further herein.

In some instances, the connected home analytics system 102 may be configured to detect and/or connect to the connected systems 108, the connected devices 112, and/or the connected sensors 114 automatically via one or more communication protocols, such as, a low-bandwidth long-range wireless communication protocol, a Bluetooth protocol (e.g., a Bluetooth Low Energy protocol), a Wi-Fi protocol, Z-wave protocol, Zigbee protocol, Thread protocol, or any other suitable public or proprietary wireless communication protocols.

As shown, the connected home analytics system 102 may be configured to receive information/data associated with one or more third-party systems 118. In some embodiments, a third-party system 118 may be associated with a weather monitoring entity, such as, for example, the national weather service. Accordingly, in certain embodiments, the connected home analytics system 102 may be configured to pull various weather information (e.g., expected rainfall, severe weather warnings, flood risk warnings, expected snowfall) associated a location of a connected home or property from the third-party systems 118.

As shown, connected home analytics system 102 may be configured to communicate with the user database 116. In certain implementations, the user database 116 may retrievably store information relating to one or more protection policies of the user and/or information relating to one or more users and/or assets of the users. In various embodiments, information/data associated with the user database 116 may be communicated to the connected home analytics system 102.

In some instances, the user database 116 may retrievably store various connected home information including, for each user, information on what types of connected devices (e.g., the connected systems 108, the connected devices 112, connected sensors 114, and/or any other assets) the user has in their home or other connected property, locations of various the connected devices and/or other relevant devices or home features (e.g., floor plans, shutoff valve locations, junction box locations, electrical wiring schematics, etc.), and/or any other pertinent information that may be utilized to enable the various functionalities described herein.

In some embodiments, the user database 116 may additionally retrievably store various policy information including, for each user, information on what types of policies the user has and details on the assets (e.g., the connected systems 108, the connected devices 112, connected sensors 114, and/or any other assets) covered by the policies (or endorsements). For instance, policies may be homeowner's policies, automotive or vehicle policies, health/medical policies, life policies, renter's policies, flight/travel insurance policies, lifestyle policies, personal articles or personal belongings policies, umbrella policies, parametric policies, commercial or business policies, business liability policies, various or related endorsements, etc.

The user database 116 may additionally retrievably store various user information including data on users that have policies associated with the provider. For example, the user information may include information relevant to policies and/or policy plans of the user, such as an age of the user, a number of dependents of the user, and/or historical location data associated with the user and/or one or more assets of the user covered by the policies and/or the policy plans. In some instances, the user information may be information obtained by the connected home analytics system 102 when a user obtains one or more policies with the provider.

### Exemplary Connected Home Analytics System

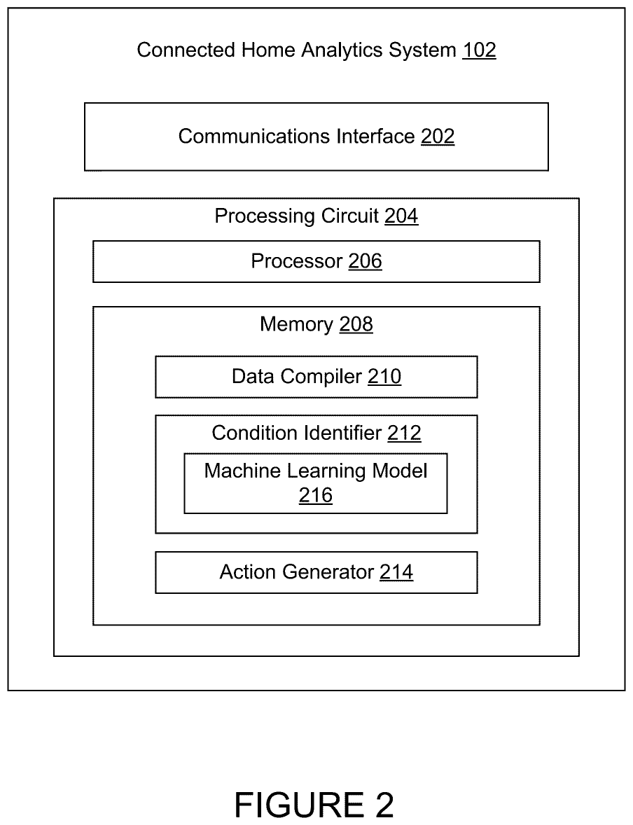

Referring to FIG. 2, the connected home analytics system 102 may include a communications interface 202 and a processing circuit 204 having a processor 206 and a memory 208. The communications interface 202 may include wired or wireless communications interfaces (e.g., jacks, antennas, transmitters, receivers, transceivers, wire terminals, etc.) for communicating data between the connected home analytics system 102 and external systems or devices (e.g., the user device 104, the connected systems 108, the connected devices 112, the connected sensors 114, the user database 116, the third-party systems 118, etc.). In some embodiments, the communications interface 202 facilitates communications between the connected home analytics system 102 and one or more external applications and/or interfaces (e.g., the user interface 106), for example to allow a remote user or operator to control, monitor, and/or adjust components of the connected home analytics system 102.

Further, the communications interface 202 may be configured to communicate with external systems and/or devices using any of a variety of communications protocols (e.g., HTTP(S), WebSocket, CoAP, MQTT, Bluetooth, Wi-Fi, near-field communication, etc.) and/or any of a variety of other protocols. Advantageously, the connected home analytics system 102 may obtain, ingest, and process data from any type of system or device, regardless of the communications protocol used by the system or device.

As shown, the connected home analytics system 102 may include the processing circuit 204 having the processor 206 and the memory 208. While shown as single components, it should be appreciated that the connected home analytics system 102 may include one or more processing circuits, including one or more processors and memory.

In some embodiments, the connected home analytics system 102 may include a plurality of processors, memories, interfaces, and/or other components distributed across multiple devices or systems, which are communicably coupled via a network (e.g., the network 120). For example, in a cloud-based or distributed implementation, the connected home analytics system 102 may include multiple discrete computing devices, each of which include a processor 206, memory 208, communications interface 202, and/or other components of the connected home analytics system 102. Tasks performed by the connected home analytics system 102 may be distributed across multiple systems or devices, which may be located within a single building or facility or distributed across multiple buildings or facilities. In other embodiments, the connected home analytics system 102 itself may be implemented within a single computer (e.g., one server, one housing, etc.). All such implementations are contemplated herein.

The processor 206 may be a general purpose or specific purpose processor, an application specific integrated circuit (ASIC), one or more field programmable gate arrays (FPGAs), a group of processing components, or other suitable processing components. The processor 206 may further be configured to execute computer code or instructions stored in the memory 208 or received from other computer readable media (e.g., USB or other local storage, network storage, a remote server, etc.).

The memory 208 may include one or more devices (e.g., memory units, memory devices, storage devices, etc.) for storing data and/or computer code for completing and/or facilitating the various processes described in the present disclosure. The memory 208 may include random access memory (RAM), read-only memory (ROM), hard drive storage, temporary storage, non-volatile memory, flash memory, optical memory, or any other suitable memory for storing software objects and/or computer instructions. In some embodiments, the memory 208 may include database components, object code components, script components, and/or any other type of information structure for supporting the various activities and information structures described in the present disclosure. The memory 208 may be communicably connected to the processor 206 via the processing circuit 204, and may include computer code for executing (e.g., by the processor 206) one or more processes described herein. When the processor 206 executes instructions stored in the memory 208, the processor 206 may configure the processing circuit 204 to complete such activities.

As shown, the connected home analytics system 102 (e.g., the memory 208) may include a data compiler 210, a condition identifier 212, and an action generator 214. The following paragraphs describe some of the general functions performed by each of the components 210-214 of the connected home analytics system 102. It should be noted that the number and type of components shown is merely illustrative and, in various implementations, implementations of the connected home analytics system 102 may have additional, fewer, and/or different components than those illustrated in FIG. 2.

In certain embodiments, the data compiler 210 may be configured to obtain input data, analyze the input data, and/or generate output data to be communicated to other components of the connected home analytics system 102 (e.g., the condition identifier 212 and/or the action generator 214). The data compiler 210 may obtain (e.g., receive, request, pull, etc.) various data associated with users, user assets (e.g., the connected systems 108, the connected devices 112, the connected sensors 114), and/or user policies held by and/or provided to the user. In some instances, the data may be received from an external system or device (e.g., the user device 104, the connected systems 108, the sensors 110 of the connected systems 108, the connected devices 112, the connected sensors 114, the user database 116, the third-party system 118, etc.), for example via the communications interface 202. For instance, the data compiler 210 may obtain various operational information (e.g., alerts, error codes, sensor readings, operational states, etc.) associated with the various connected systems 108, the connected devices 112, and/or the connected sensors 114, as well as other pertinent information relating to a connected home or property (e.g., via the user device 104, the user database 116, and/or the third-party systems 118).

In some embodiments, the condition identifier 212 may be configured to obtain input data, analyze the input data, and/or generate output data to be communicated to other components of the connected home analytics system 102. For example, the condition identifier 212 may obtain (e.g., receive, request, pull, etc.) the various information collected or compiled by the data compiler 210 and analyze the information to identify various conditions within or otherwise associated with a connected home or property, as described herein. For instance, the condition identifier 212 may be configured to apply operational information from the various smart systems and devices (e.g., the connected systems 108, the connected devices 112, the connected sensors 114), information regarding the connected home or property (e.g., retrieved or otherwise obtained from the user device 104 and/or user database 116), and/or various information pulled from third parties (e.g., from the third-party systems) to one or more machine learning models 216 to identify various conditions within the connected home or property.

In some instance, the condition identifier 212 may include one or more artificial intelligence or machine learning models 216 trained to identify and/or infer conditions within the connected home or property. In some embodiments, the machine learning models 216 may include predictive and/or generative models. For instance, the machine learning models 216 may include one or more regression trees, deep neural networks, supervised learning model, unsupervised learning models, deep learning models, combined models, ChatGPT-based models, large language models (LLMS), reinforcement models, nearest neighbor, generative adversarial networks (GANs), stable diffusers, generative artificial intelligence (GAI), transformers (e.g., pre-trained transformers), retrieval augmented generation models (e.g., machine learning models configured to obtain addition information in response to received queries for use in creating prompts for an LLM-type model), or many other types of models, including combinations of the foregoing.

In some instances, the machine learning models 216 may be trained using training data that allows for the machine learning models 216 to detect, determine, and/or infer various conditions within the connected home or property using multiple smart devices. For example, the machine learning models 216 may be trained using various technical specification information (e.g., owner's manuals), technical support manuals, troubleshooting guides (e.g., including information regarding potential error or alert codes and/or potential underlying causes), historical operational information correlated to smart home conditions (e.g., smart home scenario data), etc., to allow for the machine learning models 216 to detect, determine, and/or infer various information regarding one or more conditions of a connected home or property.

In some embodiments, the machine learning models 216 may be configured to infer various information regarding the one or more conditions of the connected home or property that are not explicitly present in the training data. For example, the machine learning models 216 may be able to identify characteristics associated with different connected devices (e.g., connected systems 108, connected devices 112, connected sensors 114) within a smart home and identify similarities or other correlations between those identified characteristics to infer various information regarding a condition within a smart home, as will be described further herein.

The action generator 214 may generate and/or perform various actions in response to conditions within the connected home or property identified by the condition identifier 212. For example, the action generator 214 may be configured to perform or otherwise initiate various actions using the various connected devices (e.g., the connected systems 108, the connected devices 112, the connected sensors 114) within the connected home or property. In some instances, the action generator 214 may be additionally or alternatively configured to generate various notifications regarding the condition of the connected home or property. For instance, the generated notifications may include a general description of the identified condition (e.g., “We have detected a water leak in the southeast corner of the basement.” In some instances, the generated notifications may additionally include various recommendations for responding to the identified condition (e.g., “We have detected a water leak in the southeast corner of the basement. Shut off your water main valve immediately and contact a plumber in your area.”). In certain embodiments, the generated notifications may additionally include various contact information and/or selectable links for contacting service technicians available near the connected home or property that may aid in responding to the identified condition.

It should be appreciated that the various recommendations, actions, notifications, etc., provided herein are provided as illustrative examples and are not meant to be limiting. In other embodiments, additionally or alternative recommendations, actions, notifications, etc., may be provided without departing from the scope of the present disclosure.

Although the machine learning models 216 are shown as part of the condition identifier 212, it should be appreciated that, in some embodiments, the action generator 214 may include the machine learning models 216 and/or other similar machine learning models. For example, the action generator 214 may include one or more artificial intelligence or machine learning models trained to determine how to respond to conditions within the connected home or property. In some embodiments, the machine learning models of the action generator 214 may similarly include predictive and/or generative models. For instance, the machine learning models of the action generator 214 may similarly include one or more regression trees, deep neural networks, supervised learning model, unsupervised learning models, deep learning models, combined models, ChatGPT-based models, large language models (LLMS), reinforcement models, nearest neighbor, generative adversarial networks (GANs), stable diffusers, generative artificial intelligence (GAI), transformers (e.g., pre-trained transformers), retrieval augmented generation models (e.g., machine learning models configured to obtain addition information in response to received queries for use in creating prompts for an LLM-type model), or many other types of models, including combinations of the foregoing.

In some instances, the machine learning models of the action generator 214 may be trained using training data that allows for the machine learning models of the action generator 214 to determine and/or infer appropriate responsive actions to identified conditions within the connected home or property. For example, the machine learning models of the action generator 214 may similarly be trained using various technical specification information (e.g., owner's manuals), technical support manuals, troubleshooting guides (e.g., including information regarding potential error or alert codes), historical operational information correlated to smart home conditions, etc., to allow for the machine learning models of the action generator 214 to determine and/or infer appropriate responsive actions to identified conditions within the connected home or property.

In some embodiments, the machine learning models of the action generator 214 may be configured to infer various information regarding responding to conditions of the connected home or property that are not explicitly present in the training data. For example, the machine learning models 216 may be able to identify characteristics associated with identified conditions within a smart home and functionalities of various connected devices (e.g., connected systems 108, connected devices 112, connected sensors 114) within the smart home, and utilize the identified characteristics and functionalities to infer various information regarding responding to conditions within the smart home, as will be described further herein.

It should be appreciated that, in some embodiments, various additional components of the connected home analytics computer system 100 (e.g., the user device 104, the connected systems 108, the connected devices 112, the connected sensors 114, the user database 116, the third-party systems 118) may include similar components to those discussed above with respect to the connected home analytics system 102 (e.g., a communications interface similar to the communications interface 202, a processing circuit similar to the processing circuit 204, a processor similar to the processor 206, a memory similar to the memory 208).

### Exemplary Connected Home Analytics System Functionality

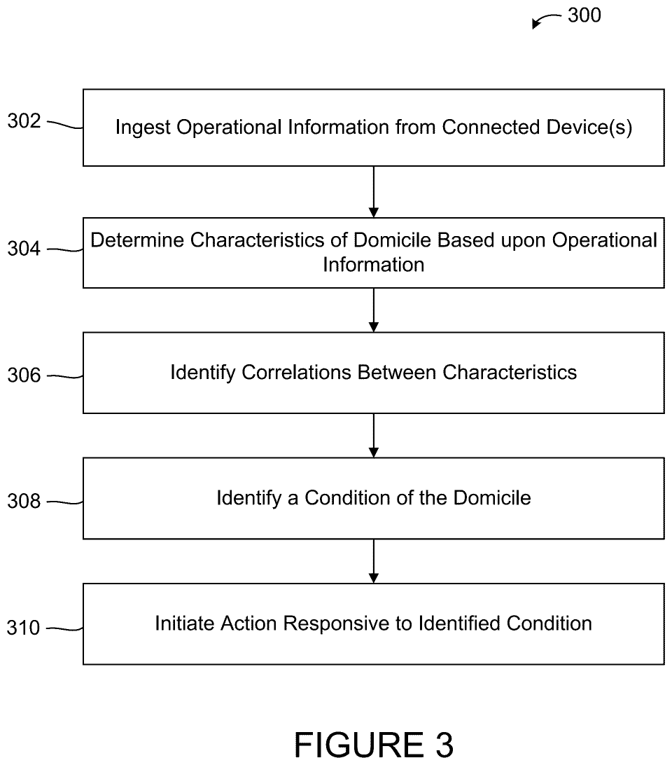

Referring now to FIG. 3, a computer-implemented or computer-based process, shown as process 300, for performing connected home analytics is shown, according to some embodiments. Computer-implemented process 300 may be implemented by any and/or all the components of the connected home analytics computer system 100 of FIGS. 1-2 (e.g., the processing circuit 204 of the connected home analytics system 102, etc.). It should be appreciated that any and/or all the process 300 may be implemented by other systems, devices, and/or components (e.g., components of the connected home analytics computer system 100, the connected home analytics system 102, etc.). Further, it should be appreciated that in some embodiments, process 300 may implemented using additional, different, and/or fewer operations, actions, and/or functionality. Additionally, the following description of the computer-implemented process 300 will make reference to plumbing-type and electrical-type characteristics, correlations, and conditions. It should be appreciated that these are provided as illustrative examples, and are in no way meant to be limiting.

Computer-implemented process 300 may include ingesting operational information from connected devices (block 302), according to some embodiments. For example, the connected home analytics system 102 may ingest operational information from a variety of connected systems and devices (e.g., the connected systems 108, the connected devices 112, the connected sensors 114) within or otherwise associated with a domicile (e.g., a connected home or property).

In some instances, the operational information may include various error codes or other alerts generated by one or more of the connected systems and devices. In some instances, the operational information may include various sensor readings (e.g., temperature data, pressure data, flowrate data, humidity data, etc.) captured by the connected systems and devices. In some instances, the operational information may include various operational state information associated with the connected systems and devices. For example, the operational state information may include an indication of whether a device is powered on or off, an indication of whether a relevant door (e.g., a smart garage door, an entry door to the domicile) is opened or closed, what intensity level a device is running at (e.g., a temperature setpoint, a fan speed, a flowrate setpoint), whether a valve is opened or closed, or any other relevant operational state information associated with a given connected system or device.

Computer-implemented process 300 may further include determining characteristics of the domicile (e.g., connected home or property) based upon the ingested operational information (block 304). For example, the condition identifier 212 (e.g., utilizing the machine learning models 216) may determine a variety of characteristics of the domicile based upon the ingested information and corresponding device information associated with the connected devices from which the ingested information is received. In some instances, the condition identifier 212 may additionally utilize various information obtained from third parties (e.g., the third-party system 118) to identify various characteristics of the domicile.

As an example of plumbing-type characteristics, if a pressure sensor (e.g., one of the connected devices 112) associated with a water pipe is showing a lower-than-expected pressure, the pressure sensor may generate an error code or alert, and the machine learning models 216 may be configured to determine, based upon the error code or alert, that the water pipe has a potential leak and that this issue has to do with or otherwise relates to a potential plumbing issue. Additionally, if a separate moisture detection sensor (e.g., another of the connected devices 112) detects moisture within another area of the domicile, the moisture detection sensor may generate an error code or alert, and the machine learning models 216 may be configured to determine, based upon the error code or alert, that there is moisture within that area of the domicile and that this issue similarly has to do with or otherwise relates to another potential plumbing issue.

As an example of electrical-type characteristics, if an electrical monitoring sensor (e.g., one of the connected devices 112) detects that there is a faulty ground connection somewhere in the house, the electrical monitoring sensor may generate an error code or alert, and the machine learning models 216 may be configured to determine, based upon the error code or alert, that the domicile has a faulty ground connection somewhere in the domicile's electrical system and that this issue has to do with or otherwise relates to potential electrical issue. Additionally, if a separate smart lamp (e.g., one of the connected devices 112) generates an alert associated with a power interruption, the machine learning models 216 may be configured to determine, based upon the error code or alert, that the smart lamp is similarly being affected by a potential electrical issue.

As an additional example of occupancy-type characteristics, in some instances, the connected home analytics system 102 may determine, based upon information from various connected devices and sensors (e.g., motion sensors, smart televisions, smart garage door openers, smart door sensors, smart thermostats, smart vehicles, mobile devices), that it is unlikely that there are occupants within the connected home or other connected property because the connected devices and sensors have not been used and/or have not detected an occupant in an extended period of time (e.g., several hours, a day, several days, etc.) and/or the user has indicated that they plan to be away from home (e.g., via a smart thermostat schedule). The connected home analytics system 102 may further determine based upon information received from a connected water heater device that the water heater is activated, which may be indicative of an occupant within the connected home or other connected property.

Computer-implemented process 300 may further include identifying correlations between the identified characteristics of the domicile (block 306). For example, the condition identifier 212 (e.g., utilizing the machine learning models 216) may further determine various correlations and/or similarities between identified characteristics of the domicile.

With reference back to the plumbing-type characteristics discussed above, the machine learning models 216 may be configured to determine that the potential water leak determined based upon the pressure sensor associated with the water pipe is likely associated with the moisture detected by the moisture detection sensor by making inferences from the training data used to train the machine learning models 216. For example, a first technical support guide associated with the pressure sensor may reference a low-than-expected pressure being indicative of leaking water and a second technical support guide associated with the moisture detection sensor may reference utilizing the moisture detection sensor to detect water pipes leaking. The machine learning models 216 may thus be configured to infer from these references that these identified characteristics associated with the domicile (i.e., the potential water leak and the detected moisture) are likely related.

With reference back to the electrical-type characteristics discussed above, the machine learning models 216 may be configured to determine that the faulty ground connection detected by the electrical monitoring sensor is likely associated with the alert generated by the smart lamp indicating the potential electrical issue. For example, an owner's manual associated with the electrical monitoring sensor may reference a number of potential devices that may be affected by a faulty ground connection, and a troubleshooting guide associated with the smart lamp may reference a likely cause of the potential electrical issue being a grounding issue. The machine learning models 216 may thus be configured to infer from these references that these identified characteristics associated with the domicile (i.e., the faulty ground connection and the potential electrical issue) are likely related.

With reference back to the occupancy-type characteristics discussed above, the machine learning models 216 may be configured to determine that, because the information from the various smart devices within the home, apart from that received from the water heater, indicate that it is unlikely that there are occupants within the connected home or other connected property, the water heater being activated is likely not indicative of an occupant being within the connected home or other connected property.

Computer-implemented process 300 may further include identifying a condition of the domicile (block 308). For example, the condition identifier 212 (e.g., utilizing the machine learning models 216) may further determine, based upon the various correlations and/or similarities between the identified characteristics of the domicile, specific conditions of the domicile. In some instances, the condition identifier 212 may additionally utilize various information obtained from third parties (e.g., the third-party system 118) to identify conditions within or otherwise associated with the domicile.

For example, with reference again to the plumbing-type characteristics and correlation discussed above, the machine learning models 216 may be configured to determine that, because the potential water leak determined based upon the pressure sensor associated with the water pipe is likely associated with the moisture detected by the moisture detection sensor, the water pipe is associated with the pressure sensor is likely leaking water into an area of the moisture detection sensor, which is causing the moisture detection sensor to detect moisture.

With reference again to the electrical-type characteristics and correlation discussed above, the machine learning models 216 may be configured to determine that, because the faulty ground connection detected by the electrical monitoring sensor is likely associated with the alert generated by the smart lamp indicating the potential electrical issue, an outlet that the smart lamp is plugged into is the likely location of the faulty ground connection detected by the electrical monitoring sensor.

With reference again to the occupancy-type characteristics and correlation discussed above, the machine learning models 216 may be configured to determine that, because the information from the water heater is likely not indicative of an occupant being within the connected home or other connected property, it is instead likely indicative of an issue with the water heater (e.g., that should likely be inspected by a service technician).

Although shown as separate steps, it should be appreciated that, in some instances, the machine learning models 216 may be configured to utilize the operational information ingested from the various connected devices to determine the characteristics of the domicile, identify the correlations between the characteristics, and/or identify the corresponding condition of the domicile within a single process step.

Computer-implemented process 300 may further include initiating an action responsive to the identified condition of the domicile (block 310). In some instances, based upon the identified condition of the domicile, the action generator 214 (e.g., utilizing the machine learning models 216 and/or other machine learning models) may generate various actions (e.g., preventative actions and/or mitigative or restorative actions) in response to identified conditions within a domicile. As used herein, preventative actions may be actions configured to prevent or otherwise lower a likelihood of a potentially damaging issue occurring within the domicile, and mitigative or restorative actions may be actions configured to mitigate damage caused by a condition of the domicile and/or restore or repair an area or connected device affected by a condition of the domicile.

In some instances, the actions generated by the action generator 214 may include generating a notification or alert regarding the identified condition within the domicile. For example, the notification or alert may include a description of the identified condition (e.g., “A leak has been detected in the southeast corner of your basement.”). In some instances, the notification or alert may be provided without any corresponding recommendations, such that the user is simply made aware of the detected condition.

In some instances, the notification or alert may further include a recommendation for responding to the identified condition. For example, the notification could include a recommended action for the user to take (e.g., “We recommend you shut off your water main valve and contact a plumber to fix the detected leak.”). In some instances, the recommended action may be one or more recommendations for how to go about fixing a particular issue within the domicile. For example, the action generator 214 (e.g., utilizing the machine learning models 216 or other similar machine learning models) may be configured to determine and provide step-by-step instructions for fixing various issues (e.g., simple plumbing issues).

As an example, if the condition identifier 212 determines that a leaky toilet valve is the likely cause of a continuous running water issue, the action generator 214 may generate (e.g., based upon publicly available training information) step-by-step instructions for how to change the toilet valve. In some instances, the action generator 214 (or another component of the connected home analytics system 102) may be configured to coordinate with a camera of the user device 104 to generate one or more augmented reality overlays for more clearly explaining the step-by-step instructions (e.g., highlighting components to be replaced or fixed within an image captured by a camera of the user device 104).

In some instances, the notification may include a link or other selectable option to activate or actuate various other connected devices (e.g., “Click here to actuate your smart shutoff valve to shut off your water main valve.”). In some instances, the notification may include a link or other selectable option to schedule a service for responding to the identified condition (e.g., “Click here to schedule a local plumber to fix your leak” or “Click here to have your personal assistant automatically schedule repair services,” the personal assistant being a generative AI app running on the customer's mobile device, or the like).

For example, the action generator 214 (e.g., utilizing the machine learning models 216 and/or other machine learning models) may be able to pull a calendar of the user and a calendar of a local contractors or service technician (e.g., pulled from the user device 104 and the third-party system 118, respectively), to identify proposed service times that work with both schedules, and to navigate an online website scheduling process to schedule a service by the service technician. In some instances, various contractors or service technicians may opt into services provided by the connected home analytics system 102 (e.g., a connected home analytics program) to allow for various scheduling integration between the user and the contractors or service technicians and to allow for the action generator 214 to navigate the online website scheduling process.

In some instances, the notifications discussed above may be provided by the action generator 214 to the user via one or more user interfaces. For example, the action generator 214 may generate any of the various notifications and/or alerts discussed above and transmit the notifications and/or alerts to the user device 104 to be displayed to the user via the user interface 106. In some instances, the notifications may be provided by the action generator 214 to the user via one or more voice assistants, chatbots, and/or any other suitable communication method (e.g., via the user device 104 and/or any other suitable device). For instance, the condition identifier 212 and/or the action generator 214 may be configured to communicate with the user (e.g., via one or more LLMs) to gather information pertaining to an identified condition or potential condition and/or to aid in determining how to appropriately respond to the condition.

In some instances, the actions generated by the action generator 214 may additionally or alternatively include automatically initiating various actions via one or more connected devices (e.g., the connected systems 108, the connected devices 112, the connected sensors 114). For example, the action generator 214 (e.g., using the machine learning models 216 and/or other similar machine learning models) may be configured to identify one or more connected devices having functionalities associated with or otherwise related to a condition of the domicile identified by the condition identifier 212. That is, the machine learning models 216 may be trained and used to identify correlations and/or similarities between the functionalities of the various connected devices and the condition of the house.

For example, if a water leak is detected within the domicile, the action generator 214 may be configured to identify a correlation between the water leak and a connected water shutoff valve configured to control the main water shutoff valve for the domicile. The action generator 214 may further be configured to automatically actuate the connected shutoff valve to close the main water line into the domicile upon detection of the leak. Similarly, if the condition identifier 212 identifies that a gas stove burner of a connected gas range has been turned on and that a flame has not ignited (e.g., based upon a temperature sensor or thermocouple reading from the connected gas range) for longer than expected (e.g., a minute), the action generator 214 may be configured to identify a correlation between the gas stove burner and a connected gas line shutoff valve installed within a gas line that supplies or is otherwise associated with the gas range. The action generator 214 may further be configured to automatically actuate the connected gas line shutoff valve to prevent the unlit burner from leaking gas into the domicile.

It will be appreciated that the various characteristics, correlations, and corresponding conditions, as well as the various notifications and automated actions, discussed above are provided as examples and are not meant to be limiting. A variety of other types of connected systems and devices may provide error codes, alerts, sensor readings, and/or operational state information and/or have differing functionalities that may be utilized by the connected home analytics system 102 in other contexts for other types of issues and/or to respond to other types of conditions generally.

In some embodiments, the connected home analytics system 102 may be configured to determine, based upon information pulled from the third-party system 118 (e.g., weather data), that the connected home or other connected property of the user is in an area that is at risk for flooding. The connected home analytics system 102 may further be able to determine, based upon information received from connected systems and devices within the user's home, that there are no or insufficient moisture detection sensors in the user's basement. In these instances, the connected home analytics system 102 may be configured to recommend to the user adding one or more moisture detection sensors within their basement.

In some embodiments, the connected home analytics system 102 may be configured to determine that the user has left their house (e.g., based upon geolocation data associated with the user device 104 and/or vehicle telematics data received from the user's vehicle) and has left their garage door or another door open (e.g., based upon information received from a smart garage device and/or a smart door sensor). Accordingly, the connected home analytics system 102 may generate an alert or notification and transmit the alert or notification to the user device 104. In some instances, in the case of a house with a smart garage device, the connected home analytics system 102 may further automatically close or provide the user with a selectable option to remotely close the garage door via the smart garage device.

In certain embodiments, the connected home analytics system 102 may be configured to monitor electrical power characteristics delivered to the user's house (e.g., via an electrical monitoring device installed within a junction box of the user's house) and, in the case that there is a power outage or inconsistent power coming from the external power source (e.g., provided via a municipality or other third party), the connected home analytics system 102 may be configured to generate an alert or notification to the user device 104. In some instances, the connected home analytics system 102 may further automatically turn on and switch or provide the user with a selectable option to turn on and switch over to a generator to power the house.

In various embodiments, the connected home analytics system 102 may be used to enable a parametric insurance policy. For example, as described herein, the connected home analytics system 102 is configured to assist with repairs associated with various identified conditions. However, in some instances, the machine learning models 216 (e.g., including an LLM) may further estimate a likely insurance payout amount associated with various identified conditions (e.g., a cost of replacing assets in a user's basement in the case of a burst pipe that goes undetected) based upon similar issues other homeowners have experienced, as well as local repair costs associated with repairing and/or costs associated with responding to the identified conditions (e.g., the cost of installing moisture detection sensors in the user's basement), and provide this information to the insurance entity associated with the connected home analytics system 102 (or a separate insurance provider computing system).

In some instances, the insurance entity associated with the connected home analytics system 102 (or a separate insurance provider computing system) may provide the user with a discount (e.g., a lower premium) and/or various rewards (e.g., gift cards) if the user responds appropriately to conditions detected or otherwise identified within their house by the connected home analytics system 102. In some instances, the insurance entity associated with the connected home analytics system 102 (or a separate insurance provider computing system) may additionally or alternatively offer various new device discounts to encourage users to install various connected devices (e.g., a sump pump monitor) within their homes and/or keep their connected devices properly updated (e.g., via downloading appropriate firmware updates) and thereby further reduce the likelihood of a large insurance payout by the insurance entity. In some instances, the connected home analytics system 102 (e.g., via the machine learning model 216) may be configured to provide a plain-language explanation of the reasoning for recommending the various connected devices and/or preventative actions to the user (e.g., via the user device 104).

In some instances, the connected home analytics system 102 may use gamification to encourage user participation and/or adherence to following the recommended actions provided to the user by the connected home analytics system 102. For example, the connected home analytics system 102 may track how many recommendations the user has acted upon (e.g., how many recommended additional connected devices have been installed within the user's house) and only provide the user with a discount and/or reward upon the user hitting a predefined threshold or goal (e.g., following ten recommendations).

Additionally, in some instances, the connected home analytics system 102 may recommend different or additional insurance coverage policies. For example, if the connected home analytics system 102 determines that the user has several high value connected devices within their home, the connected home analytics system 102 may recommend to the user that they get specific itemized coverage for those items. Similarly, the connected home analytics system 102 determines that the user has several high value connected devices located in their basement and does not currently have flood insurance, the connected home analytics system 102 may recommend to the user that they obtain a flood insurance policy.

### Exemplary Connected Home Analytics User Interfaces

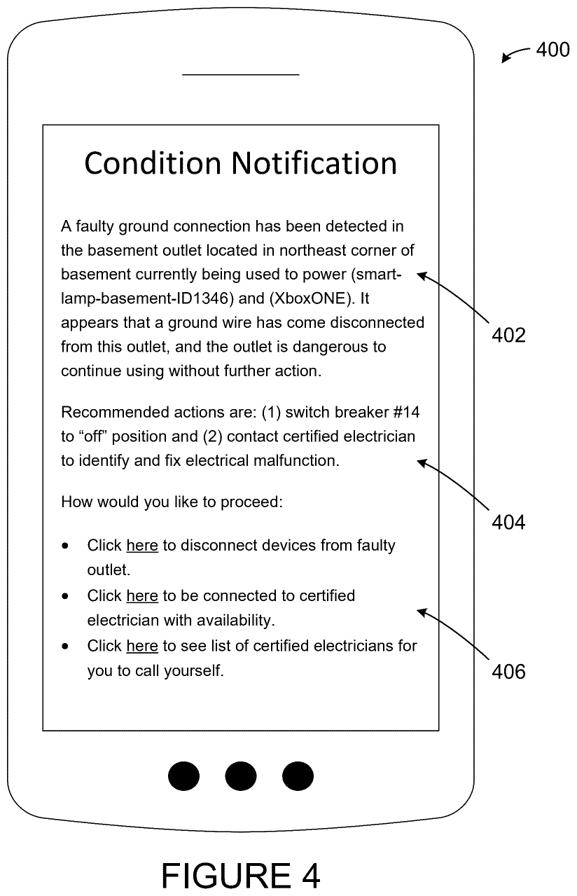

Referring now to FIG. 4, a connected home notification page (e.g., connected home notification page 400) of an application for connected home analytics is shown, according to some embodiments. The application may be accessible on any suitable electronic device, such as a mobile phone, tablet, smart home device, watch, or any other computing device. For instance, the application may be accessible on any of the connected home analytics system 102, the user device 104, and/or a user interface of the connected systems 108 (e.g., an interactive screen interface of a home security system). The application enables a user (e.g., a property owner) to, among other things, receive notifications and prompts associated with identified conditions within their connected home or other connected property and/or selectively initiate various actions for responding to the identified conditions (e.g., via the connected systems 108, the connected devices 112, and/or the connected sensors 114).

The connected home notification page 400 shown in FIG. 4 is an example condition notification user interface that may be provided to the user (e.g., via the user interface 106 of the user device 104). As illustrated, the connected home notification page 400 includes an explanation 402 of the identified condition, various recommended actions 404 for responding to the identified condition, and various selectable links 406 for initiating response actions.

As shown in FIG. 4, the explanation 402 of the identified condition indicates that a faulty ground connection has been detected in a basement outlet in the northeast corner of the basement of the user's home that is being used to power a smart lamp (e.g., “smart-lamp-basement-ID1346”) and a connected gaming system (e.g., “XboxONE”). The explanation 402 further includes additional context around the detected condition, specifying that the ground wire has come disconnected from the outlet and that the outlet is dangerous to use without further action. For example, in the scenario depicted in FIG. 4, the user may own an electrical monitoring device or a smart breaker monitoring device (e.g., a first one of the connected devices 112) that indicates to the connected home analytics system 102 that there is a faulty ground connection somewhere in the user's home. The connected home analytics system 102 may additionally receive power interruption error codes from the smart lamp and/or the connected gaming system and identify (e.g., utilizing the computer-implemented process 300 discussed above) that the faulty ground connection is likely within the outlet that the smart lamp and the connected gaming system are plugged into, thereby allowing the connected home analytics system 102 to provide a detailed explanation of the condition occurring within the user's home.

The various recommended actions 404 may further be generated by the connected home analytics system 102 for responding to the identified condition. For example, as shown in FIG. 4, the recommended actions 404 include (1) switching a particular break (e.g., “breaker #14”) to an “off” position and (2) contacting a certified electrician to identify and fix the electrical malfunction. These recommended actions 404 may similarly be generated by the connected home analytics system 102 via the computer-implemented process 300 discussed above.

The various selectable links 406 may similarly be generated by the connected home analytics system 102 and may be selectable by the user on the connected home notification page 400 (e.g., via interaction with the user interface 106 of the user device 104) to initiate various actions for responding to the identified condition. In some instances, as shown in FIG. 4, the various selectable links 406 may include a link or other selectable option configured to allow the user to disconnect devices from the faulty outlet. For example, the affected outlet may include a connected smart outlet device (e.g., one of the connected devices 112) that may be controlled by the connected home analytics system 102 via the network 120 to disconnect the smart lamp and the gaming system from the outlet having the faulty connection.

In some instances, the various selectable links 406 may further include a link or other selectable option configured to allow the user to connect to a certified electrician with availability to fix the affected outlet. For example, as described above, in some instances, various contractors or service technicians may opt into the connected home analytics services offered by the connected home analytics system 102. Accordingly, in some instances, the connected home analytics system 102 may be configured to (i) identify a certified electrician that has opted into the connected home analytics services; (ii) check whether the certified electrician has upcoming availability (and, in some cases, whether that upcoming availability matches availability of the user (such as based upon the user's electronic calendar)); and/or (iii) provide a selectable option for the user to connect with and, in some instances, schedule the service appointment for the certified electrician to come and fix the affected outlet.

In some instances, the various selectable links 406 may a include a link or other selectable option configured that simply provides a list of certified electricians for the user to contact themselves. For example, the connected home analytics system 102 may be configured to identify, via publicly available information, various certified electricians in the user's area that may be able to assist with fixing the outlet.

Accordingly, the connected home notification page 400 shown in FIG. 4 provides a clear diagnosis for exactly what has occurred within the user's home and specifically details which outlet is affected. It further notifies the user which at-risk devices are connected, and that the situation is potentially dangerous. The connected home analytics system 102 may then automatically cut power to the at-risk devices, directly connect the homeowner to the next available certified electrician, and/or curate a list of certified electricians for the homeowner to sort through and call according to their needs.

It should be appreciated that the connected home notification page 400 shown in FIG. 4 is provided as an example and is not meant to be limiting. As described herein, the connected home analytics system 102 may be configured to detect, identify, and/or respond to a variety of different types of conditions within or otherwise associated with connected homes or other connected properties.

### Exemplary Machine Learning And Generative AI

As discussed elsewhere, some embodiments may utilize machine learning, generative artificial intelligence, or other advanced computing techniques. As such, in some embodiments, generative artificial intelligence (AI) models (also referred to as generative machine learning (ML) models) and/or other AI/ML models discussed herein may be implemented via and/or coupled to one or more voice bots and/or chatbots that may be configured to utilize artificial intelligence and/or machine learning techniques. For instance, the voice and/or chatbot may be a ChatGPT chatbot and/or a ChatGPT-based bot. The voice and/or chatbot may employ supervised, unsupervised, and/or semi-supervised machine learning techniques, which may be followed by, and/or used in conjunction with, reinforced and/or reinforcement learning techniques. The voice bot, chatbot, ChatGPT bot, ChatGPT-based bot, and/or other such generative model may generate audible or verbal output, text or textual output, visual or graphical output, output for use with speakers and/or display screens of a mobile computing device, and/or other types of output for user and/or other computer or bot consumption.

Noted above, in some embodiments, a chatbot or other computing device may be configured to implement machine learning, such that the computing device “learns” to analyze, organize, and/or process data without being explicitly programmed. Machine learning and/or artificial intelligence may be implemented through machine learning methods and algorithms. In one exemplary embodiment, a machine learning module may be configured to implement the ML methods and algorithms.

As used herein, a voice bot, chatbot, ChatGPT bot, ChatGPT-based bot, and/or other such generative model (referred to broadly as “chatbot” herein) may refer to a specialized system for implementing, training, utilizing, and/or otherwise providing an AI or ML model to a user for dialogue interaction (e.g., “chatting”). Depending on the embodiment, the chatbot may utilize and/or be trained according to language models, such as natural language processing (NLP) models and/or large language models (LLMs). Similarly, the chatbot may utilize and/or be trained according to generative adversarial network (GAN) techniques, such as the machine learning techniques, algorithms, and systems described in more detail below.

The chatbot may receive inputs from a user via text input, spoken input, gesture input, etc. The chatbot may then use AI and/or ML techniques as described herein to process and analyze the input before determining an output and displaying the output to the user. Depending on the embodiment, the output may be in a same or different form than the input (e.g., spoken, text, gestures, etc.), may include images, and/or may otherwise communicate the output to the user in an overarching dialogue format.

In various embodiments, at least one of a plurality of ML methods and algorithms may be applied to implement and/or train the chatbot, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, a chatbot ML module employs supervised learning, which involves identifying patterns in existing data to make predictions about subsequently received data. Specifically, the chatbot ML module may be “trained” using training data, which includes example inputs and associated example outputs. Based upon the training data, the chatbot ML module may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiment, a processing element may be trained by providing it with a large sample of data with known characteristics or features.

In another embodiment, the chatbot ML module may employ unsupervised learning, which involves finding meaningful relationships in unorganized data. Unlike supervised learning, unsupervised learning does not involve user-initiated training based upon example inputs with associated outputs. Rather, in unsupervised learning, the chatbot ML module may organize unlabeled data according to a relationship determined by at least one ML method/algorithm employed by the chatbot ML module. Unorganized data may include any combination of data inputs and/or ML outputs as described above.

In yet another embodiment, the chatbot ML module may employ semi-supervised learning, which involves using thousands of individual supervised machine learning iterations to generate a structure across the multiple inputs and outputs. In this way, the chatbot ML module may be able to find meaningful relationships in the data, similar to unsupervised learning, while leveraging known characteristics or features in the data to make predictions via a ML output.

In yet another embodiment, the chatbot ML module may employ reinforcement learning, which involves optimizing outputs based upon feedback from a reward signal. Specifically, the chatbot ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In certain embodiments, the chatbot ML module may be used in conjunction with the machine vision, image recognition, object identification, AR glasses, VR headsets, wearables, smart devices, smart glasses, smart rings, laptops, voice bots, chatbots, other input/output devices, and/or other image processing techniques discussed below. Additionally or alternatively, in some embodiments, the chatbot ML module may be configured and/or trained to implement one or more aspects of the machine vision, image recognition, objection identification, and/or other image processing techniques discussed below.

### LLM Diagnostics for Problems Identified by Smart Home Devices

The use of GPT models or the like have potential to provide specific, personalized direction to mitigate problems associated with connected home features. Many smart devices and apps exist today to tell homeowners when something is wrong (Ting, Moen, Leakbot, etc.). However suggested fixes may be very generic and may not yet utilize LLMs to provide a list of optional paths and detailed specific direction in ways to mitigate the problem identified.

In one aspect, LLMs may provide much more specific details regarding problems in the home identified by smart home devices in the market today. By taking information derived from a connected home, the LLM may assess all connected devices and put together an analysis of the actual problem occurring rather than merely delivering a simple alert of short message to the homeowner.

Messaging may be tailored to provide specific diagnosis and remedies for detected problems. For example, in addition or alternatively to the homeowner getting a message stating, “faulty ground in basement outlet,” use of a LLM may provide the following verbal and/or visual messaging, which includes (i) precise location; (ii) detailed issue; and/or (iii) short-term and long-term remedy information:
Faulty ground in basement outlet located in northeast corner of basement currently being used to power (smart-lamp-basement-ID1346) and (XboxONE). It appears that a ground wire has come disconnected from this outlet and is dangerous to continue using without further action. Recommended actions are: switch breaker #14 to “off” position, contact certified electrician to identify and fix electrical malfunction (click here to see list of certified electricians nearby). How would you like to proceed:
   Click here to disconnect devices from faulty outlet.
   Click here to be connected to certified electrician with availability.
   Click here to see list of certified electricians for you to call yourself.

In the example above, the LLM service may be providing a very clear diagnosis for exactly what occurred and which outlet is affected. The LLM service may notify the user which at-risk devices are connected, and that the situation is or may become potentially dangerous. The LLM service of the present embodiments may automatically (a) cut power to said devices; (b) directly connect the homeowner to the next available certified electrician; and/or (c) curate a list of certified electricians for the homeowner to sort through and call according to their needs.

This model and/or LLM service of the present embodiments further may connect to a parametric insurance policy which may assist with immediate repairs associated with the diagnosis. LLM use may provide intelligence to scan like issues and estimate a payout amount based upon similar issues homeowners have experienced while also estimating local repair or replacement costs associated with repairs and/or replacements.

Further in the example above, the present embodiments may provide or generate a GUI (graphical user interface) and/or voice bot presenting an elongated or tailored verbal and/or visual communication or message, such as tailored message create by one or more generative AI models or programs, (i) detailing present and/or future damage-related or damage-causing issues; (ii) with detailed location of the issue(s), such as the location of a specific outlet or a specific smart device; (iii) short-term remedy instructions or recommendations, such as de-energize certain smart devices or open certain breakers, along with step-by-step instructions; and/or (iv) longer term remedy instructions or recommendations, such as contact a certified electrician, or repair or replace certain appliances, such as a dishwasher or refrigerator.

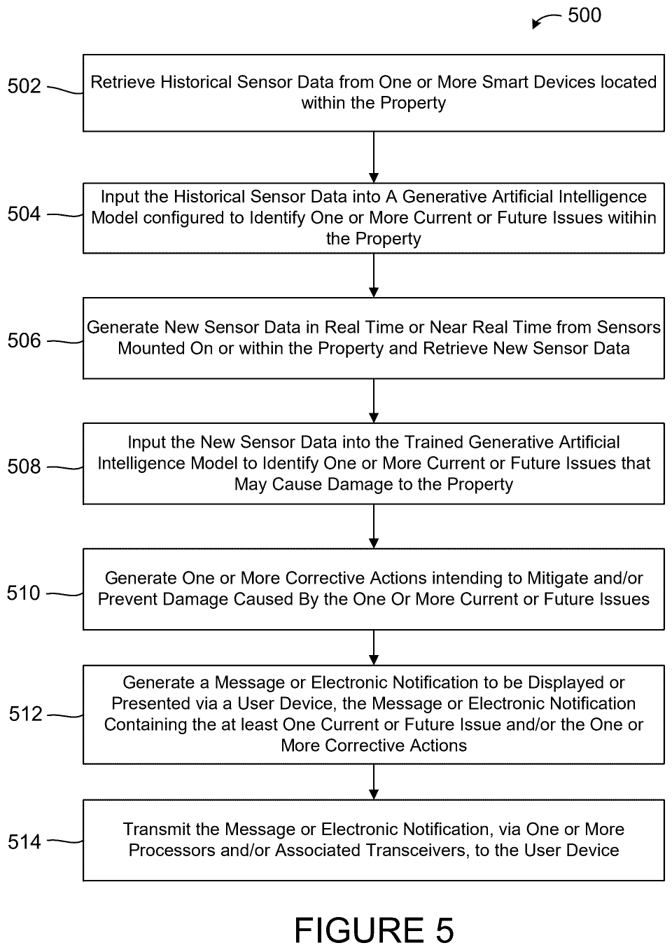

Referring to FIG. 5, a block diagram is depicted of an exemplary computer-implemented or computer-based method 500 of utilizing a trained artificial intelligence model to identify issues within a property that may be implemented. The method may be implemented via one or more local or remote processors, sensors, transceivers, servers, memory units, augmented reality glasses or headsets, virtual reality headsets, extended or mixed reality headsets, smart glasses or watches, wearables, voice bot, and/or other electronic or electrical components. For instance, in one example, the method may include (1) retrieving, via one or more processors, historical sensor data from one or more smart devices; (2) inputting the historical sensor data into a generative artificial intelligence model; (3) generating and/or receiving in real time new sensor data from the sensors; (4) inputting the new sensor data into the trained artificial intelligence model; (5) generating one or more corrective actions; (6) generating a message or electronic notification, such as detailed audible and/or visual message created by one or more generative AI programs, applications, or models the details one or more future or current issues within a home or building and location thereof, and one or more short-term and/or long-term recommendations that mitigate or prevent home damage; and/or (7) transmitting the message or the electronic notification to the user's mobile device or other computing device for presentation to the user. The method may include additional, fewer, or alternate actions, including those discussed elsewhere herein.

To this end, FIG. 5 depicts a block diagram of an exemplary computer-implemented method 500 of utilizing a trained artificial intelligence model to identify issues within a property. The exemplary method 500 may include a first block or operation 502 of retrieving sensor data from one or more smart devices within the property. The smart devices may store the sensor data in a memory device and may use one or more processors, such as microprocessors, controllers, and/or any other suitable type of processor configured to communicable coupled to or having accessibility with the memory device. The one or more processors may be remote or local.

At block 504, the historical sensor data retrieved in block or operation 502 may be used to train the generative artificial intelligence model. The generative artificial intelligence model may be configured to monitor, modify, detect, predict, identify, or mitigate one or more current or future issues within the property. The one or more current or future issues may include an issue with: plumbing, piping, structure, security, landscape, utility or other housing issues of the like. The purpose of supplying the sensor data to the generative artificial intelligence model may be to train the model.

At block 506, new sensor data may be generated and retrieved from the smart devices. The new sensor data may be generated in real time or near real time, and may be stored in at least one memory, memory unit, or memory device. Once new sensor data is generated by the one or more sensors and/or smart devices, it may be retrieved from the at least one memory, memory unit, or memory device via one or more processors.

After the new sensor data is retrieved, block 508 depicts inputting the new sensor data into the trained artificial intelligence model. Because the generative artificial intelligence model back at block 504 was trained using provided historical sensor data, the trained generative artificial intelligence model may be ready to accept new sensor data for analysis via one or more processors. Now that the generative artificial intelligence model is trained, the new sensor data may provide the trained artificial intelligence model with data that the trained model may use to identify one or more current or future issues that may cause damage to the property.

At block 510, the trained artificial intelligence model may generate one or more corrective actions to mitigate and/or prevent the one or more identified current or future issues. The one or more corrective actions generated may pertain to plumbing, piping, structure, security, landscape, utility or other housing issues of the like. The one or more corrective actions may take into account the user's home improvement abilities, offering one or more corrective actions that may be aligned to the user's skill set. The one or more corrective actions may include short-term remedial actions, such as close a water shut off valve, open a breaker, unplug an appliance or other device, etc. Additionally or alternatively, the one or more corrective actions may include long-term remedial actions, such as (i) replacing all or portion of a roof or roofing materials, one or more windows, one or more appliances, (ii) contacting a repair man or woman, or the like.

Additionally, the one or more corrective actions may include instructions to contact a referral, a preferred subject matter expert, a preferred contractor, a local contractor, or someone having skill in the art of home improvement.

The user may be unaware of the identified current or future issues or how to correct the issue. At block 512, a message or electronic notification may be generated including the one or more corrective actions and/or the one or more current or future issues. Intended to be displayed on the user device, block 514 depicts that the message or electronic notification generated in block 512 may then be transmitted via one or more processors and/or transceivers to the user device. Upon receiving the generated message or electronic notification, the user may see the one or more corrective actions to take in order to prevent and/or mitigate the identified one or more current or future issues that my cause damage to the property.

In one aspect, a computer-implemented method for utilizing a trained generative artificial intelligence model to identify an issue within a property may be provided. The method may include (1) receiving (or retrieving from a local or remote memory), via one or more local or remote processors (and/or associated transceivers) historical sensor data from one or more smart devices located within the property; (2) inputting, via the one or more processors, the historical sensor data into a generative artificial intelligence model to train the generative artificial intelligence model using the historical sensor data, the generative artificial intelligence model being configured to identify one or more current or future issues within the property; (3) generating, via one or more devices, processors, or sensors mounted on or withing the property, new sensor data in real time or near real time; (4) retrieving from a memory or receiving, via the one or more processors and/or associated transceivers, the new sensor data; (5) inputting, via the one or more processors, the new sensor data into the trained generative artificial intelligence model to identify at least one current or future issue within the property, the at least current or future issue causing or being likely to cause damage to the property; (6) based upon the at least one current or future issue within the property, generating, via the one or more processors, one or more corrective actions intending to (i) mitigate damage caused by the at least one current or future issue, and/or (ii) prevent damage caused by the at least one current or future issue (the one or more corrective actions being implemented, at least in part, by one or more local or remote processors); (7) generating, via the one or more processors, a message or electronic notification to be presented or displayed via a user device (such as displayed on a display screen or audibly presented via a voice bot), the message containing the at least one current or future issue and/or the one or more corrective actions; and/or (8) transmitting, via the one or more processors and/or associated transceivers, the message to the user device for presenting to a user to facilitate mitigating or preventing property damage and/or implementing corrective actions. The method may include additional, less, or alternate functionality, including that discussed elsewhere herein.

For instance, the computer-implemented method may include the trained artificial intelligence model performing a diagnostic analysis of the one or more devices within the property, the diagnostic analysis comprising: (i) detecting an origination location within the property for the one or more current or future issues within the house; (ii) determining one or more devices as a source of the one or more current or future issues; (iii) generating an elongated (or generative AI tailored) message, the elongated message describing the origination location within the property and the source of the one or more current or future issues; and/or (iv) transmitting the elongated message for presentation to the user via the user device. The origination location may be located at least one of the following: an outlet, a junction box, a breaker panel, under an appliance (such as dish washer or refrigerator), or the like.

Upon determining the source of the one or more current or future issues to be one or more devices located within the property, the trained artificial intelligence model may (i) retrieve firmware and software data from the one or more devices; (ii) analyze the firmware and software data; (iii) generate a notification containing a recommendation for one or more new devices, the one or more new devices having an updated firmware and software; and/or (iv) transmit the notification to the user via the user device.

The method may include the trained artificial intelligence model estimating a potential loss amount for each of the one or more corrective actions via one or more processors; generating a level of severity for each of the one more corrective actions based in part upon the potential loss amount; generating a prioritized list of the one or more corrective actions; and/or transmitting the prioritized list to the user via the user device, wherein the prioritized list displays the level of severity or the potential loss amount for the one or more corrective actions.

The one or more corrective actions may include at least one of: identifying a preferred contractor contact number, a list of local contractors, or a recommendation for one or more new devices. In certain embodiments, upon providing the preferred contractor contact number, the trained generative artificial intelligence model presents a call option to the user via the user device.

In another aspect, a diagnostic analysis device may include at least one processor in communication with at least one memory device, with the diagnostic analysis device utilizing a trained generative artificial intelligence model to identify an issue within a property. The at least one processor of the diagnostic analysis device may be programmed to: (1) receive via one or more transceivers historical sensor data from one or more smart devices located within the property; (2) input the historical sensor data into a generative artificial intelligence model; (3) train the generative artificial intelligence model using the historical sensor data, the generative artificial intelligence model may be configured to identify one or more current or future issues within the property; (4) retrieve from a memory via one or more devices within the property using one or more processors new sensor data in real time; (5) input the new sensor data into the trained generative artificial intelligence model; (6) identify one or more current or future issues within the property, along with detailed locations thereof; (7) generate one or more corrective actions intending to mitigate damage caused by the one or more current issues or prevent damage caused by the one or more future issues; (8) generate a visual and/or audible message to be presented to a user, the message containing at least the one or more corrective actions and the location of the one or more current or future issues; and/or (9) transmit the message to the user via a user device via one or more transceivers. The diagnostic analysis device may include additional, less, or alternate functionality, including that discussed elsewhere herein.

For instance, the diagnostic analysis device may further include the trained artificial intelligence model performing a diagnostic analysis of the one or more devices within the property, the diagnostic analysis may include (i) detecting an origination location within the property for the one or more current or future issues within the house; (ii) determining one or more devices as a source of the one or more current or future issues; (iii) generating an elongated message (such as a tailored message generated or created by generative AI), the elongated message describing the origination location within the property and the source of the one or more current or future issues; and/or (iv) transmit the elongated message for visual or audible presentation to the user via the user device.

For instance, the origination location may be at least one of the following: an outlet, a junction box, a breaker panel, under or beneath an appliance (such as dish washer or clothes dryer), within building materials, such as within a wall of a structure or under floorboards, or the like.

Upon determining the source of the one or more current or future issues to be one or more devices located within the property, the trained artificial intelligence model may (i) retrieve firmware and software data from the one or more devices; (ii) analyzes the firmware and software data; (iii) generates a notification containing a recommendation for one or more new devices, the one or more new devices having an updated firmware and software; and/or (iv) transmits the notification for presentation to the user via the user device.

The diagnostic analysis device may be configured to have the trained artificial intelligence model (i) estimate a potential loss amount for each of the one or more corrective actions via one or more processors; (ii) generate a level of severity for each of the one more corrective actions based in part upon the potential loss amount; (iii) generate a prioritized list of the one or more corrective actions; and/or (iv) transmit the prioritized list to the user via the user device, wherein the prioritized list displays the level of severity or the potential loss amount for the one or more corrective actions.

The one or more corrective actions may include at least one of identifying a preferred contractor contact number, a list of local contractors, or a recommendation for one or more new devices. In certain embodiments, upon providing the preferred contractor contact number to user, the trained generative artificial intelligence model may present a call option to the user via the user device.

### Exemplary Computer-Based Method Using Generative AI

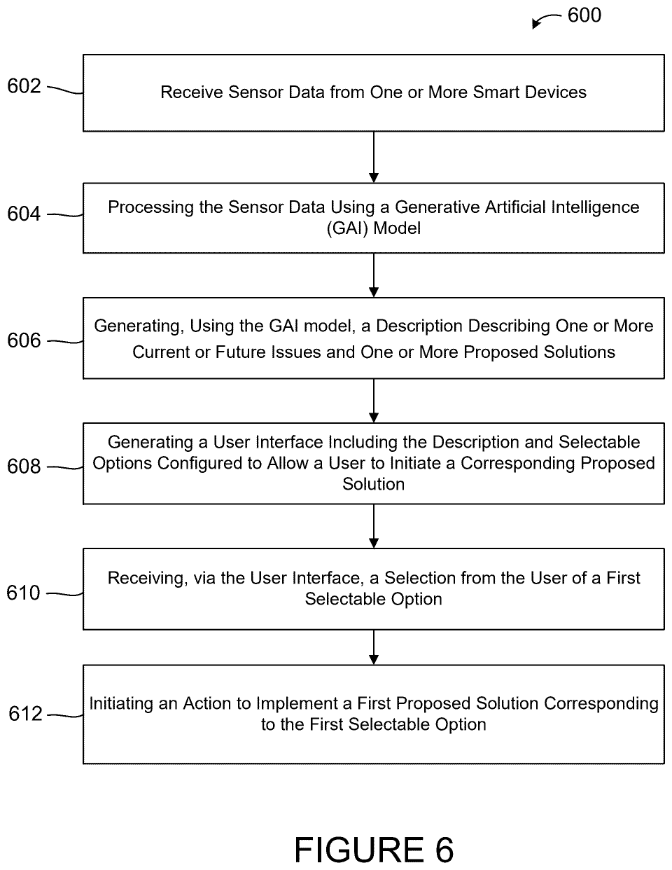

Referring now to FIG. 6, a block diagram is depicted of another exemplary computer-implemented or computer-based method 600 of utilizing a trained artificial intelligence model to identify issues within a property that may be implemented. The method may be implemented via one or more local or remote processors, sensors, transceivers, servers, memory units, augmented reality glasses or headsets, virtual reality headsets, extended or mixed reality headsets, smart glasses or watches, wearables, voice bot, and/or other electronic or electrical components. For instance, in one example, the method may include (1) receiving, via one or more processors, sensor data from one or more smart devices; (2) processing, via the one or more processors, the sensor data using a generative artificial intelligence (GAI) model trained to identify one or more current or future issues within the property, at least one of a location or a source of the one or more current or future issues, and one or more proposed solutions for addressing the one or more current or future issues using the sensor data; (3) generating, using the GAI model, a description describing the one or more current or future issues, the at least one of the location or the source, and the one or more proposed solutions; (4) generating, via the one or more processors, a user interface including the description and one or more selectable options, each selectable option configured to allow a user to initiate a corresponding proposed solution of the one or more proposed solutions; (5) receiving, via the user interface, a selection from the user of a first selectable option from among the one or more selectable options; and/or (6) initiating, via the one or more processors, an action to implement a first proposed solution of the one or more proposed solutions corresponding to the first selectable option. The method may include additional, fewer, or alternate actions, including those discussed elsewhere herein.

To this end, FIG. 6 depicts a block diagram of the exemplary computer-implemented method 600 of utilizing a trained artificial intelligence model to identify issues within a property. The exemplary method 600 may include a first block or operation 602 of receiving, via one or more processors, sensor data from one or more smart devices. For example, in some instances, the sensor data may be received by the connected home analytics system 102 from one or more of the connected systems 108, the connected devices 112, and/or the connected sensors 114.

At block 604, the sensor data received in block or operation 602 may be processed using one or more generative artificial intelligence (GAI) models. For example, the one or more GAI models may be trained to identify one or more current or future issues within the property, at least one of a location or a source of the one or more current or future issues, and one or more proposed solutions for addressing the one or more current or future issues using the sensor data. In some instances, one or more of the GAI models may be trained to generate a natural language description describing the one or more current or future issues, the at least one of the location or the source, and/or the one or more proposed solutions.

In some instances, the connected home analytics system 102 may obtain various training data to utilize while training the GAI model (e.g., the machine learning model 216). For example, the training data may include (i) historical sensor data from various smart devices (e.g., the connected systems 108, the connected devices 112, the connected sensors 114, and/or a variety of other smart devices), (ii) functionality information pertaining to one or more functionalities of the various smart devices (e.g., device actuation characteristics pertaining to how each device actuates, operational information related to operating characteristics of each device, error or fault information associated with errors or faults that may be generated by each device, etc.), and/or (iii) historical issue identifications for various issues detected and corresponding to the historical sensor data. In some instances, the historical issue identifications may include various solutions/resolutions (e.g., steps taken to resolve each identified issued).

Accordingly, the connected home analytics system 102 may apply or otherwise input the various training data into the GAI model to train the GAI model to identify various current and/or future issues, various locations and/or sources of the current and/or future issues, and various proposed solutions for addressing the current or future issues. In some instances, the one or more GAI models may be or may include one or more large language models (LLMs) configured to infer various information not explicitly recited or otherwise present within the training data. For example, the one or more LLMs may be able to identify characteristics associated with different smart devices and/or sensors (e.g., connected systems 108, connected devices 112, connected sensors 114, other smart devices) within a smart home and identify similarities or other correlations between those identified characteristics to cross-correlate information from the different smart devices and/or sensors to infer various information relating to conditions within the smart home. Accordingly, the one or more LLMs may be configured to identify various current or future issues, location and/or the sources of current or future issues, and/or proposed solutions for addressing the current or future issues that are not explicitly present within the training data.

Accordingly, the connected home analytics system 102 may process the received sensor data (e.g., real-time sensor data, near real-time sensor data, continuously retrieved sensor data, periodically retrieved sensor data) using the one or more GAI models (e.g., one or more LLMs) to identify various current or future issues within the property, a location and/or a source of the current or future issues, and/or various proposed solutions for addressing the current or future issues using the sensor data.

At block 606, the connected home analytics system 102 may generate a description of the current or future issues, the locations and/or sources of the current or future issues, and/or the various proposed solutions. For example, as discussed above, one or more of the GAI models (e.g., the machine learning model 216) may be trained to generate a natural language description describing the current or future issues, the locations and/or the sources, and/or the various proposed solutions. For example, as shown in FIG. 4, the natural language description could specify: “A faulty ground connection has been detected in the basement outlet located in northeast corner of basement currently being used to power (smart-lamp-basement-ID13s46) and (XboxONE). It appears that a ground wire has come disconnected from this outlet, and the outlet is dangerous to continue using without further action. Recommended actions are: (1) switch breaker #14 to ‘off’ position and (2) contact certified electrician to identify and fix electrical malfunction.”

In some instances, the connected home analytics system 102 may further generate an explanation of a cross-correlation of sensor data utilized to identify the current or future issues. For example, as discussed above, the GAI models may be trained to cross-correlate various information from different devices to identify issues within a property. In some instances, one or more of the GAI models may further be configured to generate an explanation (e.g., a natural language explanation) of the information used when identifying the current or future issues. For example, the natural language explanation generated could specify: “Both the lamp and the gaming console connected to the outlet in the northeast corner of the basement are indicating issues relating to an electrical issue, and the main breaker for the house is indicating that there is a grounding issue somewhere in the house. Based upon these indications, it is likely that the ground wire has come disconnected within the outlet in the northeast corner of the basement.”

At block 608, the connected home analytics system 102 may generate a user interface including the description and one or more selectable options. For example, as shown in FIG. 4, the user interface (e.g., connected home notification page 400) may include a plurality of selectable options or links (e.g., selectable links 406), and each selectable option may be configured to allow a user to initiate a corresponding proposed solution (e.g., “disconnect devices from faulty outlet,” “connect to a certified electrician with availability,” “see list of certified electricians for you to call yourself,” etc.). In some instances, the user interface may further include the generated explanation of the information used when identifying the current or future issues discussed above. In some instances, the various proposed solutions may include various solutions configured to prevent or mitigate damage caused by the current or future issues, as well as solutions configured to resolve the current or future issues (e.g., long-term solutions).

In some instances, the selectable options may allow for a user to interact with various smart devices within the property via the user interface. For example, in some instance, upon the user selecting one of the selectable options on the user interface, the connected home analytics system 102 may generate and transmit a command to one or more of the smart devices in the property to disconnect the smart device(s) from a power source, power down the smart device(s), power on the smart device(s), actuate the smart device(s), and/or or modify a set point or other functionality of the smart device(s).

In some instances, the selectable options may allow for a user to contact a service technician (e.g., an electrician, a plumber, a heating and cooling technician) via the user interface (e.g., via a pop-up chat window). For example, in some instances, the connected home analytics system 102 may be configured to enable communication between the user device 104 and one or more third-party systems 118 via the user interface (e.g., via various API calls and/or other connections). In some instances, the selectable options may allow for a user to additionally or alternatively have contact information for the service technician (e.g., obtained from the one or more third-party systems 118) displayed to the user (e.g., via a pop-up window or a separate user interface).

At block 610, the connected home analytics system 102 may receive, via the user interface, a selection from the user of a selectable option corresponding to a proposed solution. The connected home analytics system 102 may then initiate a corresponding action (e.g., transmitting a command to a smart device, contacting a service technician, providing instructions on actions for the user to take, or any of the various other actions described herein) to implement the selected proposed solution corresponding to the first selectable option, at block 612.

In some instances, after receiving the selection from the user, the connected home analytics system 102 may feed the user's selection back into the one or more GAI models to provide feedback to allow for the one or more GAI models to learn the user's preferences. Accordingly, in some instances, the one or more GAI models may provide more tailored proposed solutions to the user (e.g., ordering proposed solutions that are more likely to be acted on by the user first, highlighting likely solutions that are more likely to be selected by the user).

In some instances, the user may be allowed to ask the connected home analytics system 102 for additional information regarding an identified potential issue, an identified potential location or cause of the issue, and/or a proposed solution. For example, before selecting one of the selectable options discussed above, the user may ask via a user interface (e.g., via a chatbot interface, a typed query) whether the identified potential issue is a common issue; whether there are any safety concerns associated with the issue, location, or proposed solutions; and/or how much a given proposed solution is likely to cost. Accordingly, in some instances, the connected home analytics system 102 may receive, via the user interface, a query for additional information from the user. The connected home analytics system 102 may then generate (e.g., using one or more of the GAI models described herein) and provide a response to the query including the additional information requested by the user. For example, the connected home analytics system 102 (e.g., using the one or more GAI models) may be configured to determine a commonness of a given issue; potential safety concerns associated with the issue, the location and/or source of the issue, and/or the proposed solutions; a likely cost of the proposes solutions; and/or any other information related to the identified issues based upon the training data used to train the one or more GAI models and inferences made therefrom.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In some embodiments, a computer program is provided, and the program is embodied on a computer readable medium. In some embodiments, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The construction and arrangement of the systems and methods as shown in the various example embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied, and the nature or number of discrete elements or positions can be altered or varied. Accordingly, all such modifications are intended to be included within the scope of the present disclosure. The order or sequence of any process or method operations, actions, or functionality may be varied or re-sequenced according to alternative embodiments. Other substitutions, modifications, changes, and omissions can be made in the design, operating conditions, and arrangement of the example embodiments without departing from the scope of the present disclosure.

As used herein, an element or operation recited in the singular and proceeded with the word “a” or “an” should be understood as not excluding plural elements or operations, unless such exclusion is explicitly recited. Furthermore, references to “exemplary embodiment,” “one embodiment,” or “some embodiment” of the present disclosure are not intended to be interpreted as excluding the existence of additional embodiments that also incorporate the recited features.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The patent claims at the end of this document are not intended to be construed under 35 U.S.C. § 112(f) unless traditional means-plus-function language is expressly recited, such as “means for” or “step for” language being expressly recited in the claim(s).

Although the Figures show a specific order of method operations, actions, or functionality, the order of such may differ from what is depicted. Also, two or more operations, actions, or functionalities may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection operations or actions, processing operations or actions, comparison operations or actions, and decision operations or actions.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The term “coupled” and variations thereof, as used herein, means the joining of two members directly or indirectly to one another. Such joining may be stationary (e.g., permanent, or fixed) or moveable (e.g., removable, or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

In various implementations, the functionality and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular industrial environment or portion of an industrial environment. Additionally or alternatively, the operations may be performed by a combination of one or more central or offsite computing devices/servers and one or more local controllers/computing devices. All such implementations are contemplated within the scope of the present disclosure.

Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A connected home analytics system comprising:
one or more memory devices having instructions stored thereon that, when executed by one or more processors, cause the one or more processors to perform operations comprising:
ingesting first operational information from a first connected device of a domicile and second operational information from a second connected device of the domicile;
identifying, using at least one machine learning model, one or more conditions of the domicile based upon a combination of the first operational information and the second operational information; and
initiating one or more actions responsive to identifying the one or more conditions of the domicile.

2. The connected home analytics system of claim 1, wherein the one or more actions comprise an automated response using one of the first connected device, the second connected device, or another connected device of the domicile.

3. The connected home analytics system of claim 1, wherein the one or more actions comprise generating a notification regarding the one or more conditions of the domicile.

4. The connected home analytics system of claim 3, wherein the notification includes a recommendation for responding to the one or more conditions of the domicile.

5. The connected home analytics system of claim 1, wherein the at least one machine learning model comprises a large language model (LLM), and wherein identifying the one or more conditions of the domicile comprises:
determining, using the LLM, at least one first characteristic of the domicile based upon the first operational information and at least one second characteristic of the domicile based upon the second operational information;
identify, using the LLM, a correlation between the at least one first characteristic and the at least one second characteristic; and
identifying, using the LLM, the one or more conditions of the domicile based upon the correlation between the at least one first characteristic and the at least one second characteristic, wherein at least one of the correlation or the one or more conditions is inferred by the LLM and is not explicitly present in training data used to train the LLM.

6. The connected home analytics system of claim 1, wherein at least one of the first connected device or the second connected device is enabled for wireless communication.

7. The connected home analytics system of claim 1, wherein one of the first operational information or the second operational information includes an alert generated by the first connected device or the second connected device.

8. The connected home analytics system of claim 7, wherein another of the first operational information or the second operational information includes one of a sensor reading or an operational state associated with the first connected device or the second connected device.

9. A computer-implemented method for performing connected home analytics, the computer-implemented method comprising:
ingesting operational information from a first connected device of a domicile;
identifying, using at least one machine learning model, one or more conditions of the domicile based upon the first operational information;
identifying, using the at least one machine learning model, a second connected device of the domicile based upon the one or more conditions of the domicile and a functionality of the second connected device; and
initiating one or more actions for responding to the one or more conditions of the domicile using the second connected device responsive to identifying the one or more conditions of the domicile and to identifying the second connected device.

10. The computer-implemented method of claim 9, wherein the at least one machine learning model comprises a large language model (LLM), and wherein identifying the second connected device comprises:
identify, using the LLM, a correlation between the one or more conditions and the functionality of the second connected device, wherein the correlation is inferred by the LLM and is not explicitly present in training data used to train the LLM.

11. The computer-implemented method of claim 9, wherein at least one of the first connected device or the second connected device is enabled for wireless communication.

12. The computer-implemented method of claim 9, wherein the operational information includes an alert generated by the first connected device.

13. The computer-implemented method of claim 9, wherein the operational information includes one of a sensor reading or an operational state associated with the first connected device.

14. A non-transitory computer-readable medium comprising instructions stored thereon that, when executed by one or more processors, cause the one or more processors to perform operations comprising:
ingesting first operational information from a first connected device of a domicile and second operational information from a second connected device of the domicile;
determining, using at least one machine learning model, a first characteristic of the domicile based upon the first operational information and a second characteristic of the domicile based upon the second operational information;
identifying, using the at least one machine learning model, one or more conditions of the domicile based upon a correlation between the first characteristic and the second characteristic; and
initiating one or more actions responsive to identifying the one or more conditions of the domicile.

15. The non-transitory computer-readable medium of claim 14, wherein the one or more actions comprise an automated response using one of the first connected device, the second connected device, or another connected device of the domicile.

16. The non-transitory computer-readable medium of claim 14, wherein the one or more actions comprise generating a notification regarding the one or more conditions of the domicile.

17. The non-transitory computer-readable medium of claim 16, wherein the notification includes a recommendation for responding to the one or more conditions of the domicile.

18. The non-transitory computer-readable medium of claim 14, wherein the at least one machine learning model comprises a large language model (LMM), and wherein at least one of the correlation or the one or more conditions is inferred by the LLM and is not explicitly present in training data used to train the LLM.

19. The non-transitory computer-readable medium of claim 14, wherein one of the first operational information or the second operational information includes an alert generated by the first connected device or the second connected device.

20. The non-transitory computer-readable medium of claim 19, wherein another of the first operational information or the second operational information includes one of a sensor reading or an operational state associated with the first connected device or the second connected device.
